(19) United States
(12) Patent Application Publication
(10) Pub. No.: US 2005/0105717 A1
(43) Pub. Date: May 19, 2005

(54) Telephony interface apparatus

(76) Inventor: Craig Timothy Lawrie, Clarence Gardens (AU)

Correspondence Address: Fulwider Patton Lee & Utecht;Howard Hughes Center, 6060 Center Drive, 10th Floor, Los Angeles, CA, 90045, US

(21) Appl. No.: 10/482,439

(22) PCT Filed: Jun. 28, 2002
(86) PCT No.: PCT/AU02/00851

(30) Foreign Application Priority Data
Jun. 29, 2001 (AU) PR 6042

(51) Int. Cl. H04M 1/00; H04M 9/00

(52) U.S. Cl. 379/388.01

(57) ABSTRACT

A telephony interface apparatus adapted to interface between a telephony device and a headset, the apparatus including: control means for controlling functions of the apparatus; function selection means coupled to the control means for selecting one of the functions; a rotationally movable dial coupled to the control means for selecting a setting of a selected function by movement of the dial; and digital display means for displaying the setting.

### FIELD OF THE INVENTION

The present invention relates generally to telephony interface apparatus. More particularly, the invention relates to digital telephony apparatus interposed between a headset and a telephony device for suppressing audio telephony signals which may be harmful to the human ear.

### BACKGROUND

Occasionally, intense, unwanted signals accidentally occur within the telephone network. These signals are variously called acoustic shocks, audio shocks, acoustic shrieks, or high-pitched tones. The exact source of an individual acoustic shock is usually unknown, but various sources are possible, such as alarm signals, signalling tones, or feedback oscillation.

Although these high-pitched tones can affect anyone, people using a regular hand-held telephone can quickly move the phone away from their ear, thus limiting their sound exposure to a fraction of a second.

Call-centre operators, however, usually use a head-set, which takes considerably longer to remove from the ear were an intense sound to occur. They thus receive a greater noise exposure than for people using hand-held phones. The problem may be exacerbated if call centres are so noisy that the operators need to have the volume controls on their telephones turned up higher than would be necessary in a quieter place.

Unexpected high-level sounds have been reported to cause a variety of symptoms. Symptoms that have been reported during the exposure include discomfort and pain. Symptoms that have been reported in the few minutes after the exposure include shock and nausea. Symptoms that have been reported to continue for some time after the exposure include headaches, nausea, tenseness, and hypersensitivity (discomfort) to loud sounds that would previously have caused no problems. In some cases, these symptoms are reported to continue for many days or weeks after the incident, although more commonly the symptoms are short-lived. Some operators who experience an acoustic shock may feel apprehensive about using the phone or about loud sounds in general.

The mechanism causing the adverse symptoms is not known with certainty. It seems highly likely, however, that the sound exposure elicits an acoustic startle reflex. (The same startle reflex can also be elicited by an unexpected touch or puff of air to the eyes). When startle occurs, numerous muscles in the upper limbs, shoulders, neck, eye and ear (the stapedius muscle and the tensor tympani muscle) are activated. If the noise exposure is loud, or if the person is in an aroused state (e.g. anxious, fearful) prior to the startle, the magnitude of the muscular response is heightened. It seems possible that the ongoing symptoms are the after-effects on the muscles and ligaments caused by the muscles being tensed to an unusual degree.

It is well established that the emotional state of a person affects the startle response (Butler et al., 1990; Cook et al., 1991, Grillon et al., 1993). A fearful state, for instance, lowers the threshold of sound at which the startle reflex occurs, and increases the magnitude of the response when it does occur (Cook et al., 1992). It thus seems possible that call-centre operators who fear that they will be injured by an acoustic shock may truly be at greater risk of injury than those who are not apprehensive about the likelihood of an incident. If this is true, then incidents are more likely to occur in call centres in which incidents have previously occurred than in call centres in which there have been no previous incidents.

The link between startle response and emotional state opens the possibility that the after-effects of an incident have a self-perpetuating element even without further headset use: Loud sounds normally elicit the stapedius muscle, either with or without a startle response. If such muscle action causes further pain or discomfort soon after an incident, the person affected may become more apprehensive about loud sounds in general, thus increasing the likelihood of further startle reactions.

Current methods to protect against acoustic shock involve limiting the voltage delivered to the headphones so that the sound level delivered to the ear is also limited in some way. Two forms of limiting are used. The first, peak clipping, acts instantaneously, but simultaneously creates distortion. The second is called compression limiting, and involves the rapid reduction of the gain of the device. Compression limiting creates less distortion, but there is a conflict between the need to reduce the gain slowly (to avoid distortion) and the need to reduce the gain quickly (to provide rapid protection from high level signals on the telephone line).

One problem with current forms of limiting is that the devices limit the voltage delivered to the headphones in a frequency-independent manner. Because the headphones produce different sound levels at different frequencies for the same input voltage, the limiting produced at the eardrum depends on the characteristics of the headphone. In particular, headphones of the type used in telephony are known to emphasise high-frequency sounds relative to low-frequency sounds. Conventional limiting systems thus limit low-frequency sounds to lower levels than they limit high-frequency sounds. As acoustic shocks are believed to be caused by high-frequency sounds, the standard solution is not well matched to the problem.

An additional (and greater) problem for conventional limiting systems is that there is a severe compromise between selecting a limiting level that is low enough to protect against acoustic shock, but high enough to allow good intelligibility when phone operators listen in noisy environments to speech from callers. The literature on the acoustic startle response (which is believed to underlie the acoustic shock problem) suggests that even very low volume levels can lead to a startle if the sound (such as a high-pitched tone) is perceived by the operator to be dangerous. It is believed that with current methods of limiting it is not possible to choose any limiting level that simultaneously protects against acoustic shock and achieves good intelligibility.

Prior art amplification systems avoid acoustic feedback by selectively reducing the gain of the devices in the chain that are causing the feedback oscillation. The acoustic shock problem is different, in that the headphones and limiting amplifier are not necessarily part of the chain of devices that are causing the feedback.

Prior art acoustic shock protection devices are generally analogue in nature and suffer from problems such as those mentioned above. Such devices also offer limited display and controllability of device settings. Also, such devices are usually configured to operate only with a particular headset and are not suited for or capable of accommodating headsets having different frequency response characteristics.

It is desired to address or ameliorate one or more of the shortcomings of the prior art.

### SUMMARY OF THE INVENTION

The present invention provides a telephony interface apparatus adapted to interface between a telephony device and a headset, the apparatus including:
control means for controlling functions of said apparatus;
function selection means coupled to said control means for selecting one of said functions;
a rotationally movable dial coupled to said control means for selecting a setting of a selected function by movement of said dial; and
digital display means for displaying said setting.

The present invention further provides a telephony interface apparatus adapted to interface between a telephony device and a headset, the apparatus including:
control means for controlling audio telephony filter settings of said apparatus;
selection means coupled to said control means for selecting one of said filter settings from a plurality of stored ones thereof, each of said stored filter settings corresponding to respective different frequency response characteristics of different types of said headset.

Preferably, the apparatus has a plurality of filter settings stored in a memory thereof, each of said stored filter settings corresponding to respective different frequency response characteristics of different types of said headset and wherein one of said filter settings is selectable by operation of said function selection means in combination with said dial.

Preferably, the apparatus is adapted to receive a first audio telephony signal from the telephony device, filter the received signal in order to attenuate shrieks in the received signal and to transmit a second audio telephony signal to the headset.

Preferably, the apparatus further includes an analog-to-digital converter for converting the received first audio telephony signal from analog to digital form before filtering thereof and a digital-to-analog converter for converting the filtered signal from digital to analog form before transmission thereof as the second audio telephony signal.

Preferably, the apparatus is further adapted to receive a third audio telephony signal from the headset and to transmit a fourth audio telephony signal to the telephony device. Preferably, the apparatus has mute means operable such that when a mute function is applied to the apparatus, said fourth audio telephony signal is not transmitted to the telephony device.

Preferably, the apparatus further includes status indicator means for indicating an operational status of the apparatus. Preferably, the status indicator means is formed as a light ring and is disposed around the dial. Preferably, the light ring has a plurality of LEDs for illumination thereof in one of two or more colours. Preferably, the LEDs illuminate the light ring in red when a mute function is applied to the apparatus or when the apparatus is turned off and in green when the mute function is not applied.

Preferably, the control means is a microcontroller adapted to receive input from the dial and the function selection means, to determine said setting of the selected function setting based on the received input, to store said determined setting and to output a display signal to the display means to display the setting. Preferably, the apparatus further includes a digital signal processor in communication with the microcontroller and adapted to detect the presence of a high signal level within an audio frequency range of a first audio telephony signal and to attenuate the high signal level in said first audio telephony signal.

Preferably, the function selection means is a mode button disposed on an upper surface of the apparatus. Preferably, when the mode button is pressed once, a setting adjustment mode is initiated and a first function is selected, the settings of said first function being adjustable by movement of the dial. Preferably, when the mode button is pressed more than once while in said setting adjustment mode, further functions may be selected, the settings of the further functions being adjustable by movement of said dial. Preferably, if the apparatus is in the setting adjustment mode and if the mode button is not pressed or the dial is not moved within a predetermined time period, the setting adjustment mode is exited.

Preferably, the dial has a substantially flat upper surface with a depression therein for engagement with a finger to rotate said dial. Preferably, the dial is disposed in a raised portion of an upper surface of said apparatus. Preferably, the dial is rotatable clockwise or anti-clockwise without a mechanical limit on the number of revolutions through which it can be rotated.

Preferably, the digital display means includes a 7-segment alphanumeric display and a 10-segment bar display and wherein LEDs are used to illuminate said alphanumeric and bar displays.

Preferably, the headset includes a microphone and a speaker for transceiving the third and second audio telephony signals, respectively.

Advantageously, the function selection means allows a user of the apparatus to change the user settings. Advantageously, the rotational dial, in combination with the function selection means, can be used to vary a number of different user settings, instead of having separate controls for each user setting.

One embodiment of the invention relates to an amplifying device adapted to detect the presence of one or more high-pitched narrow bandwidth signals within audio telephony signals, in isolation or in the presence of speech signals, and perform rapid, selective attenuation of the one or more narrow bandwidth signals to levels lower than those that occur at the same frequencies when speech is received in the absence of such high-pitched signals.

Advantages of this embodiment include:

1. The greatly reduced level of high-pitched tones makes them less dangerous to operators;

2. The effectiveness of the device can be demonstrated to operators, which should alleviate their concern over acoustic shock, which further reduces the likelihood of an acoustic shock occurring.

Additional features of this embodiment include:

Identification of the high pitched narrow band signal by computation of the frequency spectrum of the incoming sounds, and comparison of the level at each frequency with the level at nearby frequencies.

Creation of an array of band-reject filters having different centre frequencies, and selection of the filter or filters with centre frequency or frequencies closest to the frequency or frequencies of the high-pitched tone or tones detected.

Rapid but progressive fading-in of the filters.

Use of a filter with frequency characteristics inverse to that of the headphone used so that the maximum level at eardrum can be limited in a controlled manner as a function of frequency.

Implementation of the manual volume control such that some of the gain variation occurs prior to limiting and some occurs subsequent to liming.

Application of dual-speed compression limiting to the prevention of acoustic shock.

Variation of the operation of the automatic volume control depending on whether the operator is speaking or silent.

Presetting the gain of the automatic volume control at the start of each new call.

Decreasing the gain of the automatic volume control whenever the incoming call level drops below a predetermined value.

### BRIEF DESCRIPTION OF THE DRAWINGS

The drawings appended hereto and described below are illustrative of embodiments of the invention and should not be construed as limiting the invention to only those embodiments described.

FIG. 1 is a block diagram of an arrangement employing an apparatus of an embodiment of the invention;

FIG. 2 is a block diagram illustrating digital signal processing steps employed by an embodiment of the invention;

FIG. 3 is a perspective view of an apparatus of an embodiment of the invention;

FIG. 4 is a block diagram of internal components of the apparatus of an embodiment of the invention;

FIG. 5 is a block diagram of software components associated with a microcontroller unit employed by an embodiment of the invention;

FIG. 6 is a block diagram which illustrates control of bar and digit displays of an embodiment of the apparatus;

FIG. 7 is a block diagram of software components associated with a digital signal processing unit employed by the apparatus of an embodiment of the invention;

FIG. 8 is a graph illustrating attenuation of an input signal achievable according to one embodiment of the invention;

FIGS. 9A to 9D are schematic diagrams relating to digital signal processor, microcontroller, timing, watchdog and user control functions of the apparatus;

FIGS. 10A to 10D are schematic diagrams relating to CPLD, memory, CODEC and serial interface functions of the apparatus;

FIGS. 11A to 11D are schematic diagrams relating to headset interface functions of the apparatus;

FIGS. 12A to 12C are schematic diagrams relating to telephone console/handpiece functions of the apparatus;

FIGS. 13A to 13C are schematic diagrams relating to internal power supply functions of the apparatus;

FIGS. 14A to 14D are schematic diagrams relating to user display functions of the apparatus; and

FIGS. 15A to 15D are schematic diagrams of internal logic functions of a CPLD employed by the apparatus.

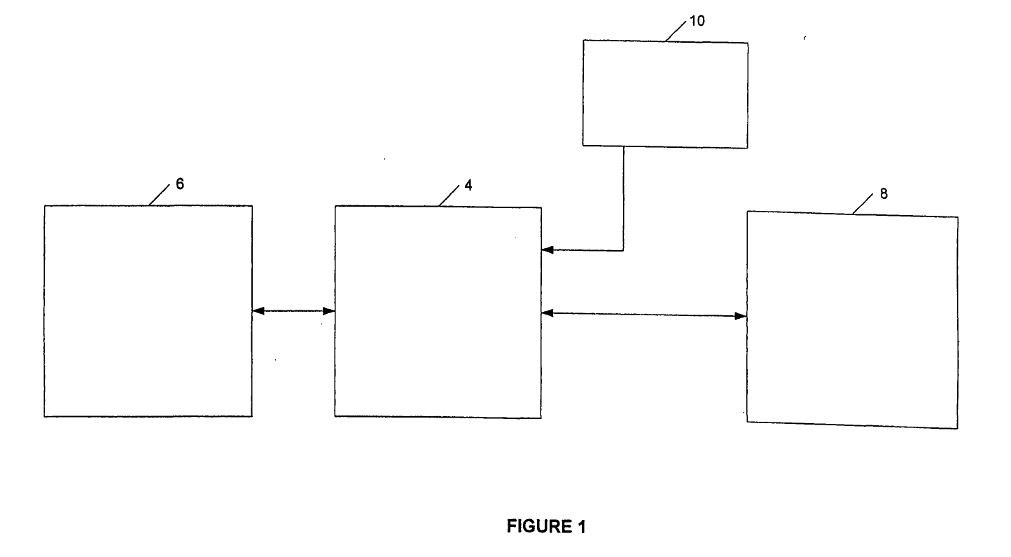

### DETAILED DESCRIPTION OF THE PREFERRED EMBODIMENTS

Preferred embodiments of the invention relate to an interface device 4 for communicating, with a telephone headset 6 and telephony device 8 which may be a normal telephone to which a headset can be connected. The interface device 4 is powered by a power supply 10, which is either separate or alternatively derived from telephony device 8.

The interface device 4 receives incoming telephony signals from the telephony device 8 in analogue form, digitally processes these signals after D/A conversion and forwards the signals on to the headset 6 (after reconversion to analogue form), with a processing delay in the order of less than 2 milliseconds. The interface device 4 acts as a sound shield and screens out unwanted audio signals from interface device 8 in favour of normal voice signals. The interface device 4 also receives voice signals back from the headset 6 and passes these through to the telephony device 8 without processing by the digital signal processor (described later). However, if a mute function of the interface device 4 is activated, voice signals received from headset 6 are blocked from transmission to the telephony device 8.

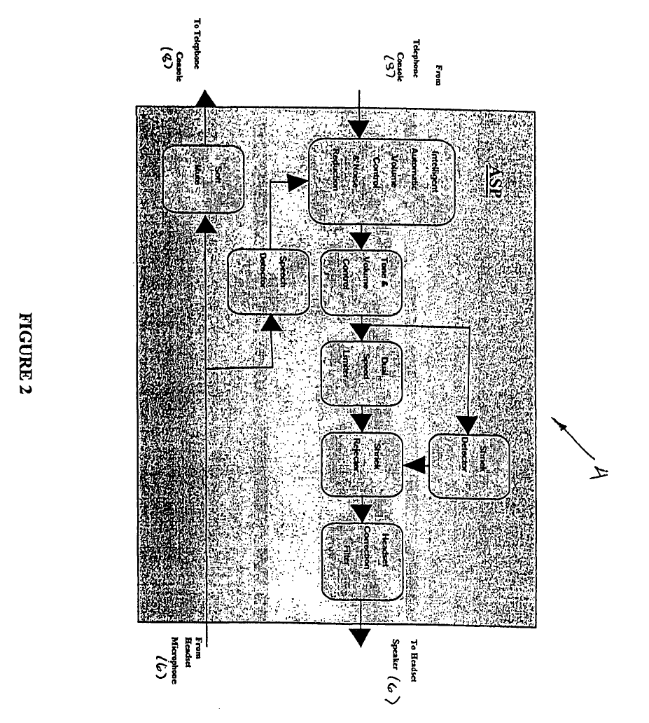

The signal processing chain executed by the interface device 4 is shown schematically in FIG. 2. This chain is implemented as digital signal processing software loaded onto a digital signal processing integrated circuit. The functions of the interface device 4 are broadly described below.

An intelligent automatic volume control and noise reduction function operates as a slowly varying automatic volume control. It automatically alters the gain of the device to compensate for variations in level of the incoming calls. One feature of this device is that the gain is frozen at its previous value whenever the operator is talking. This prevents the problem of the gain slowly increasing when the caller is not talking because the caller is listening to the operator talk. A second feature is that the gain is rapidly set to a preset value at the start of a new call. The start of a new call is detected by monitoring for signalling tones that precede each call. A third feature is that the amount of gain is reduced once the level of the incoming call falls below some pre-determined amount. This is to prevent excessive amplification of line noise.

A tone and volume control function alters the gain as a function of frequency according to a preset frequency response curve. The manual volume control within this function enables the operator to vary the level of the sound emerging from the device by changing the gain of the device. Some of the gain variation caused by operation of the volume control is applied prior to the signal being limited, and some (not shown in diagram) is applied after the signal is limited. Compared to altering the gain only prior to limiting, this combination reduces the small amount of distortion that would otherwise be caused by limiting the signal. Compared to altering the gain only subsequent to limiting, this combination minimizes the likelihood of unexpected strong input signals causing a high level at the output when the volume control has been adjusted to a high setting.

A dual-speed limiter function limits the level of signal by rapid reduction of the gain. One signal detector causes a very rapid reduction of gain to a certain level. A second detector causes a less rapid reduction to a lower level.

A shriek detector function detects the presence of narrow-band, sustained sounds and measures their frequency or frequencies. Such sounds are not characteristic of speech, but are characteristic of sounds that lead to acoustic shock. Detection is achieved by calculating the frequency spectrum of the sound present during short, successive intervals of time. If the level at one frequency exceeds the level at nearby, but not immediately adjacent, frequencies by more than a predetermined amount, and if this condition is maintained for more than a predetermined amount of time, a shriek is determined to be present at that frequency.

A shriek rejector function rapidly applies a band-reject filter or filters to reduce the gain at the frequency or frequencies at which the shriek detector has determined a shriek to be present. A feature of this is that the degree of attenuation provided at the frequency of the shriek is progressively increased as the duration of the shriek increases. This feature prevents degradation of sound quality if the shriek detector incorrectly and momentarily indicates that a shriek is present.

A headphone correction filter function imparts a gain-frequency response related to the inverse of the frequency response characteristic of the headphone connected to the device. Different frequency response curves are downloaded to, and stored in, the device as part of or following manufacture, and will be applicable depending on the frequency characteristic of the individual headphone connected to the device. The frequency characteristic of the tone control is designed to compensate for deficiencies in the frequency characteristic of the headphones.

User Interface Functions

The interface device 4 user interface serves two main purposes. Firstly it allows a user to adjust and display such device variables as Volume and Tone (plus other variables). This is referred to as the User Role (UR). Secondly, it allows the manufacturer to configure the device for working with various models of headset and types of host/console (ie the telephony device to which the interface device is connected). This is referred to as the Maintenance Role (MR).

A variable is any operational parameter that can be adjusted using one or a combination of controls. Variable values are displayed using LED indicators. These will be more fully described below.

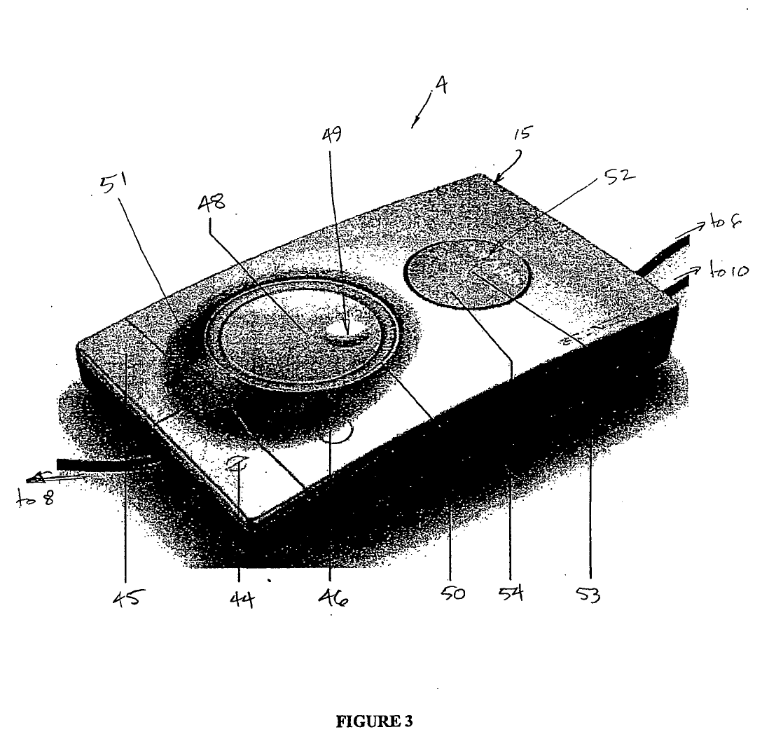

FIG. 3 shows the preferred form of the interface device 4. It has a housing 15 within which is located various circuit components as described below. The housing 15 has the following control elements which are accessible to a user:
Dial 48—This is a rotary controller for adjustment of variable values. Clockwise movement increases the value. Anti-clockwise movement decreases the value.
Headset button 45—This is a control for switching the audio path between headset and handpiece ports.
Mute button 44—This is a control for muting and un-muting the headset microphone. When pressed in combination with Mode, the Mute button changes operation to MR
Mode button 46—This is a control for selecting the variable such as volume or tone to be adjusted by the Dial 48. When pressed in combination with Mute, the Mode button changes operation to MR
Light Ring 50—This is a tri-colour (red, yellow, green) indicator for indication of the Interface device 4 operational status (e.g. Muted or otherwise).
Digit Display 54—This is a single digit, 7 segment indicator for displaying integer variables and dial mode.
Bar Display 53—This is a ten segment, horizontally aligned indicator for displaying level variables.

Variables are only valid or in use when the headset 8 is selected. When the handpiece is selected, the interface device 4 functionality is bypassed as the handpiece is connected directly to the host/console 6.

UR Variables

Volume

Used by the interface device 4 to control signal level presented to the headset earpiece. Volume assumes values between 1 and 20, 1 being softest and 20 being loudest. Each value represents a change of 1 dB from the previous higher or lower value. A user presses the mode button 46 to select volume, which is displayed on the display 54. The user can then rotate the dial 48 to alter the volume, the level of which will be displayed on the bar display 53.

At power on, Volume is restored to the value it held prior to power being removed.

Tone

Used by the interface device 4 to control the timbre of the signal presented to the headset earpiece. Tone assumes values of LOW, MID and HIGH. LOW enhances lower frequencies with respect to MID. MID is the reference response. HIGH enhances higher frequencies with respect to MID. Again, the user presses the mode button 46 to select tone and then rotates the dial 48 to alter the tone, with corresponding information being shown on the displays 53 and 54.

At power on, Tone is restored to the value it held prior to power being removed.

Mute

Holds the state of the Mute control by pressing of the mute button 44. Mute assumes the values ON or OFF. When ON, the headset microphone is muted. When OFF, the microphone is not muted.

At power on, Mute is restored to the value it held prior to power being removed.

Headset

Holds the state of the Headset control by pressing the headset button 45. Headset assumes the values ON or OFF. When ON, the headset is selected and the interface device 4 processes all signals before delivering them to the earpiece. When OFF, the handpiece is selected and the interface device 4 is bypassed.

At power on, Headset is restored to the value it held prior to power being removed.

MR Variables

The MR mode can be entered by simultaneous pressing of the buttons 44 and 46. After entering the MR mode, the mode button 46 can be operated to display the following operations on the display 54. The dial 48 can then be used to change parameter values and these will be displayed on the bar display 53.

Transmit

Used by the interface device 4 to control the level of signal sent to the host/console port (transmit connection). Transmit assumes values between 1 and 10, each value representing a change of 2 dB from the previous higher or lower value. At power on, Transmit is restored to the value it held prior to power being removed.

Receive

Used by the interface device 4 to control the level presented to the signal processing software module from the host/console port (receive connection). Receive assumes values of LOW, MID and HIGH. LOW is selected for consoles with low output level. MID is selected for consoles having average output levels. HIGH is selected for consoles with high output level.

At power on, Receive is restored to the value it held prior to power being removed.

HeadsetType

Used by the interface device 4 to select headset frequency response modification filters and level normalisation for each of the supported headset types. HeadsetType assumes values 0 to 19, allowing up to 20 Headset profiles. HeadsetType 0 selects the test headset that can be used to cause the signal processing module to pass through all signals without frequency correction or level normalisation. It is used for maintenance and test purposes.

The User Interface control software does not allow selection of a HeadsetType for which no profile data is available. Ie. If the interface device 4 contains data for 5 headset profiles, selection of an HeadsetType higher than 5 will not be permitted.

At power on, HeadsetType is restored to the value it held prior to power being removed.

LimiterType

Used by the Interface device 4 to select the sound pressure limiting profile. LimiterType assumes values between 0 and 9. LimiterType 0 selects the test limiter that does not perform any modification of the signal level and can be used for maintenance and test purposes, therefore allowing up to 10 Limiter profiles.

The User Interface control software does not allow selection of a LimiterType for which no data is available. Ie. If the Interface device 4 contains data for 2 limiters, selection of a LimiterType higher than 2 will not be permitted.

At power on, LimiterType is restored to the value it held prior to power being removed.

Shared Variables

DialMode

DialMode holds the name of the variable to be adjusted by movement of the Dial and the name of the variable will be displayed by the display 54. DialMode will assume values of VOLUME, TONE, TRANSMIT, RECEIVE, HEADSET and LIMITER.

At power on, DialMode is set to VOLUME.

Normally, four User Role (UR) adjustments are defined. The method used to implement controls may allow addition of other adjustments. The Dial mode is controlled by the Mode button 46. The Mode button steps sequentially through the available adjustments as defined in the user interface (UI) software module. The number of modes and hence the number of variable adjustments is limited by system memory and the level of usability to be achieved. The software is configured such that UR adjustments and indications are functional only when the headset is selected.

Dial Mode

The function of the Dial is determined by the Mode button. If no control has been operated for 2 seconds or longer, the Dial will assume its default mode: Volume adjustment. If the Mode button is pressed once, the Dial mode changes to Tone. If Mode is not pressed again within 2 seconds of any other control operation, Dial mode returns to Volume adjustment. Quick sequential pressing of the Mode button toggles through the various Dial modes.

Volume (Default)

Twenty discrete Volume levels are provided. Volume is increased by rotating the Dial clockwise. Each ‘click’ of rotation increases Volume by 1 dB provided it is not already at maximum. Further clockwise rotation at maximum volume has no effect. Volume is decreased by rotating the Dial 48 anti-clockwise. Each ‘click’ of rotation decreases Volume by 1 dB provided it is not already at minimum. Further anti-clockwise rotation at minimum volume has no effect.

The adjustment Dial 48 is detented on its underside and, as it is turned, a temporary increase in the force is required to rotate the Dial out of each detente until it is seated in the next detente. For ease of reference, this movement into and out of each detent will be called a ‘click’. The Dial 48 can be rotated in either direction indefinitely without being limited by a mechanical stop. The Dial 48 has its upper surface a depression 49 for engagement by a finger of the user to easily enable the dial to be turned.

Volume is indicated using the bar display 53. When Volume is at minimum (1), the left most segment is illuminated. Incrementing to the next odd value (3, 5, 7 . . . 19) causes the segment directly to the right of any illuminated segments to be illuminated. Decrementing to the next even value (18, 16, 14 . . . 2) causes the right most illuminated segment to be extinguished. When Volume is at maximum (20), all 10 segments are illuminated.

Tone

To perform Tone adjustment, the Mode button 44 must be pressed once.

The digit display 54 displays ‘t’ indicating Tone adjustment is selected and the bar display 53 displays the current setting (see below). Normally, three options are provided for Tone: Low, Mid and High. The Low setting provides a ‘Rich’ timbre and is selected by moving the Dial 48 anti-clockwise one or two ‘clicks’ depending on the prior Tone setting. The Low Tone setting is indicated by illumination of the two left most Bar segments in the display 53. Further anti-clockwise movement of the Dial has no effect. ‘Timbre’ is the tonal quality or content of a sound and may alternatively be described by the term ‘Frequency Spectrum’ to connate the same concept in a quantitative way. The Mid setting does not accentuate any frequency more than any other and is selected by moving the Dial 48 clockwise one ‘click’ if the prior setting was Low or anti-clockwise one ‘click’ if the prior setting was High. The Mid tone setting is indicated by illumination of the two centre most Bar segments in the display 53. The High setting provides a ‘Bright’ timbre and is selected by moving the Dial 48 clockwise one or two ‘clicks’ depending on the prior setting. The High Tone setting is indicated by illumination of the two right most Bar segments in the display 53. Further clockwise movement of the Dial has no effect. The software is configured such that tone adjustment should be performed within two seconds of selecting Tone mode or the Dial will revert to Volume adjustment. The two second timeout period is reset each time the Dial is moved.

Headset/Handpiece Select

Selection of the Headset or Handpiece is accomplished by pressing the Headset button 45. Successive presses of the Headset button 45 will toggle selection between headset and handpiece (not shown, but which can be coupled to the device 4 and operate in a similar way to the headset 6).

Headset selection is indicated by a Ring LED. The Ring LED 50 is an annular array of LEDs which surrounds the dial 48. When the headset is selected and the microphone is not muted, the Ring LED 50 is illuminated Green. If speech/signal is detected by the interface device 4 the Ring LED 50 flickers between Green and dark (no colour). The rate of flicker depends on the level and quantity of speech detected. When the handpiece is selected, NO indicators apart from the heartbeat (referred to below) are illuminated (the protection functions of Interface device 4 are bypassed when the handpiece is selected so this function is used to indicate that the device is inactive).

Headset Microphone Mute

The headset microphone Mute state is toggled by successive operations of the Mute button 46. If the microphone is currently muted, pressing the Mute button 46 places it in a non-muted state. If not muted, pressing the Mute button 46 mutes the headset microphone. Microphone Mute status is indicated by the Ring LED 50. The Ring LED 50 glows Red when the microphone is muted. It flickers between red and dark when the microphone is muted and distant end speech/signal is detected by the interface device 4. The Ring LED 50 glows or flicker green when the microphone is not muted.

MR Adjustments

Four Maintenance Role adjustments are defined. Like the User Role, additional adjustments may be implemented by updating the interface device 4 software. To change to MR from UR, both Mode and Mute buttons 46 and 44 must be pressed simultaneously as mentioned previously. Entry to MR is indicated by the Digit display 54 displaying a flashing ‘t’. UR adjustment mode is resumed if no control is operated for two seconds. Selection of the MR mode activates the Headset (and hence the interface device 4) so that any adjustments can be evaluated immediately.

Dial Mode

The function of the Dial on entry to MR is Transmit level adjustment.

If the Mode button 44 is operated within 2 seconds of any other control operation, Dial mode changes to Receive sensitivity adjustment. If the Mode button 44 is operated again within 2 seconds of any other control operation, Dial mode changes to HeadsetType selection. If the Mode button 44 is operated again within 2 seconds of any other control operation, Dial mode changes to LimiterType selection. If no control is operated for 2 seconds or longer, the Dial resumes its default adjustment mode: Volume (and drops out of MR back to UR).

Transmit Level

The initial adjustment after changing to MR is Transmit level. Transmit level controls the signal level transmitted to the console/host from the headset microphone. The Digit display 54 flashes ‘t’ indicating [T]ransmit adjustment is selected and the Bar display 53 displays the current setting (see below). Ten discrete Transmit levels are normally provided. Transmit level is increased by rotating the Dial 48 clockwise. Each ‘click’ of rotation increases Transmit level by 2 dB provided it is not already at maximum. Further clockwise rotation at maximum Transmit level has no effect. Transmit level is decreased by rotating the Dial anti-clockwise. Each ‘click’ of rotation decreases Transmit level by 2 dB provided it is not already at minimum. Further anti-clockwise rotation at minimum level has no effect. Transmit level is indicated using the Bar display 53. When Transmit is at minimum (1), the left most segment is illuminated. Incrementing to the next higher value causes the segment directly to the right of any illuminated segments to be illuminated. Decrementing to the next lower value causes the right most illuminated segment to be extinguished. When Transmit is at maximum, all 10 segments are illuminated.

Transmit level adjustment must be performed within two seconds of selecting Transmit mode or the Dial 48 reverts to Volume adjustment. The two second timeout period is re-started each time the Dial 48 is moved.

Receive Level

Receive level controls how much signal is received by the interface device 4 from the host/console. The Digit display 54 flashes ‘r’ indicating [R]eceive adjustment is selected and the Bar display 53 displays the current setting as described below. Three options are provided for Receive level: Low, Mid and High. The Low setting provides 15 dB more amplification than the Mid setting to cater for low output consoles. Low is selected by moving the Dial 48 anti-clockwise one or two ‘clicks’ depending on the prior Receive setting. The Low Receive setting is indicated by illumination of the two left most Bar segments. Further anti-clockwise movement of the Dial has no effect. The Mid setting provides a level of amplification suitable for the majority of consoles. It is selected by moving the Dial 48 clockwise one ‘click’ if the prior setting was Low or anti-clockwise one ‘click’ if the prior setting was High. The Mid Receive setting is indicated by illumination of the two centre most Bar segments. The High setting provides 15 dB less amplification than the Mid level to cater for consoles with high output levels. High is selected by moving the Dial 48 clockwise one or two ‘clicks’ depending on the prior setting. The High Receive setting is indicated by illumination of the two right most Bar segments of the display 53. Further clockwise movement of the Dial has no effect. Receive level adjustment must be performed within two seconds of selecting Receive mode or the Dial 48 will revert to Volume adjustment. The two second timeout period is reset each time the Dial 48 is moved.

Headset Type

HeadsetType adjustment informs the Interface device 4 signal processing software which headset correction filter and level adjustment values are to be used.

When HeadsetType adjustment is selected, the Digit display 54 flashes the current value of HeadsetType (0 to 9 without the decimal point or 10 to 19 with the decimal point) and the left most segment of the display 53 flashes to indicate HeadsetType adjustment is active. Twenty individual Headset types can be selected; 0 to 19, although selection of HeadsetTypes for which no profile data is available is not permitted.

HeadsetType is increased by rotating the Dial 48 clockwise. Each ‘click’ of rotation increments HeadsetType by 1 provided it is not already 19 or equal to the number of headset profiles stored in the system if this value is less than 19. Further clockwise rotation after 19 (or number of profiles) has been reached has no effect. HeadsetType is decreased by rotating the Dial 48 anti-clockwise. Each ‘click’ of rotation decrements HeadsetType by 1 provided it is not already 0. Further anti-clockwise rotation after 0 has been reached has no effect. HeadsetType is indicated using the Digit display 54. The type number is displayed alone for 0 to 9 or in combination with the left half of the Bar display 53 for 10 to 19. The digit and Bar displays 54 and 53 are arranged to flash during adjustment. HeadsetType adjustment must be performed within two seconds of selecting Headset mode or the Dial 48 reverts to Volume adjustment. The two second timeout period is reset each time the Dial 48 is moved.

Limiter Type

LimiterType adjustment informs the interface device 4 signal processing software which acoustic protection profile to use. When LimiterType adjustment is selected, the Digit display 54 flashes the current value of LimiterType and the right most segment of the Bar display 53 flashes to indicate LimiterType adjustment is active. Ten individual Limiter types can be selected; 0 to 9, although selection of a LimiterType for which no data exists is not permitted. LimiterType is increased by rotating the Dial 48 clockwise. Each ‘click’ of rotation increments LimiterType by 1 provided it is not already 9 or equal to the number of limiters stored in the system if this is a value less than 9. Further clockwise rotation after 9 (or number of limiters) has been reached has no effect. LimiterType is decreased by rotating the Dial 48 anti-clockwise. Each ‘click’ of rotation decrements LimiterType by 1 provided it is not already 0. Further anti-clockwise rotation after 0 has been reached has no effect. LimiterType is indicated using the Digit LED. The type number flashes during adjustment. LimiterType adjustment must be performed within two seconds of selecting Limiter mode or the Dial reverts to Volume adjustment. The two second timeout period is reset each time the Dial is moved. At all times the interface device 4 has power available, the Digit display 54 decimal point flashes like a heartbeat to indicate the device is functioning correctly. If the decimal point stops flashing, this indicates that an unrecoverable error has been encountered or power has been lost.

Hardware

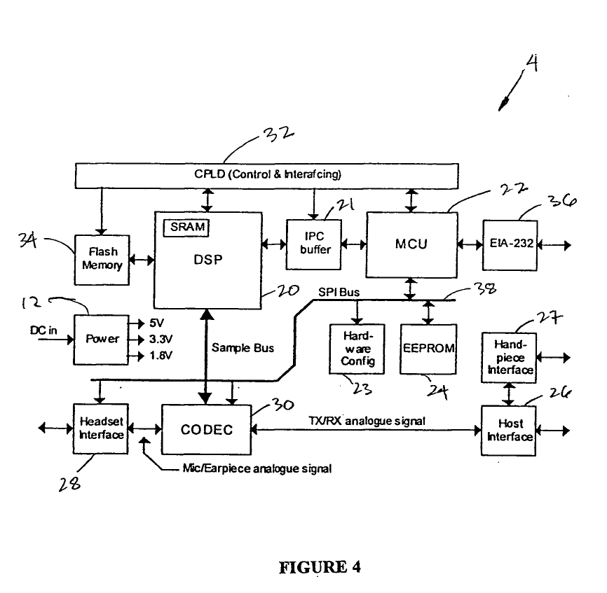

FIG. 4 shows a block diagram of an embodiment of hardware used to implement the system.

The core of the hardware is a 32 bit floating point Digital Signal Processor 20 (such as Texas Instruments TMS320VC33PMC60). A support micro-controller 22 (such as Atmel AT90LS8535) is incorporated to provide control and communication interfaces for the device.

Analogue signals are converted to digital form and digital to analogue by a 16 bit, 2 channel CODEC 30 (such as AKM AK4532 (COder DECoder)). Audio signals are converted using a sampling frequency of 8 kHz providing 4 kHz audio bandwidth suitable for telephony communications. The CODEC 30 performs anti-alias filtering.

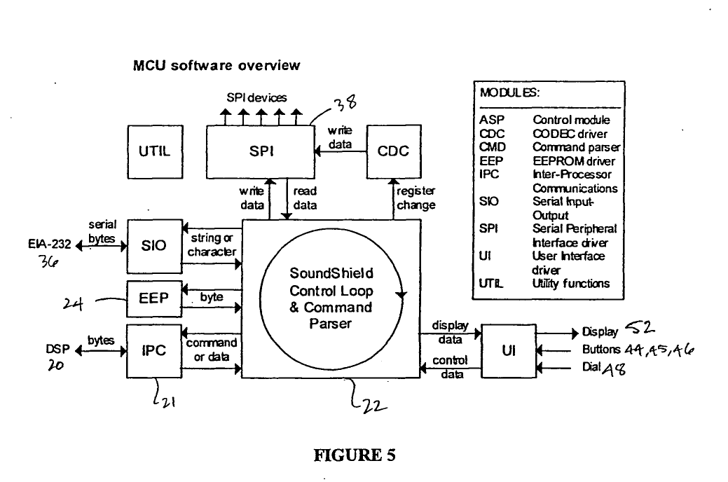

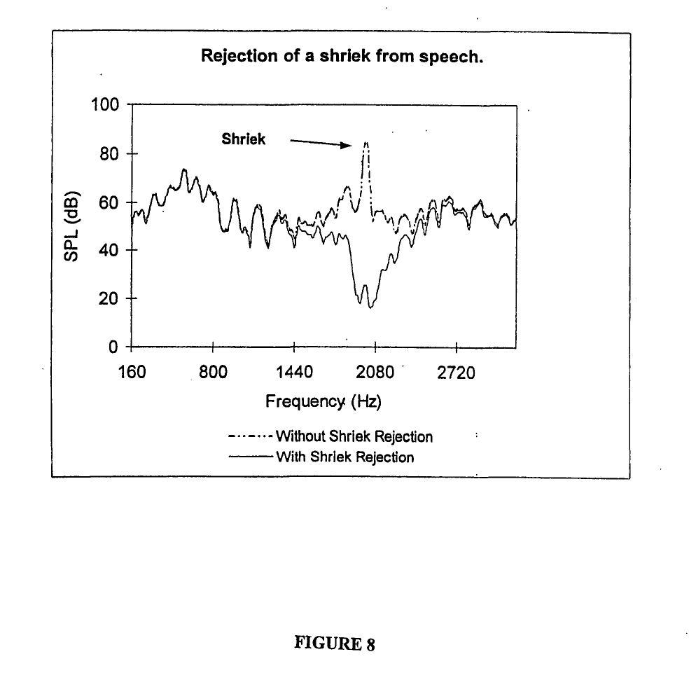

As described above, FIG. 4 shows the basic hardware layout of the preferred embodiment of the device 4. It will be appreciated by those skilled in the art that the configuration of FIG. 4 can be implemented in various ways. In the description which follows, a typical circuit implementation for the system shown in FIG. 4 will be described. The detailed operation will be apparent to those skilled in the art and therefore only some of the more important functions of the circuitry shown in FIGS. 5 to 15 will need to be described.

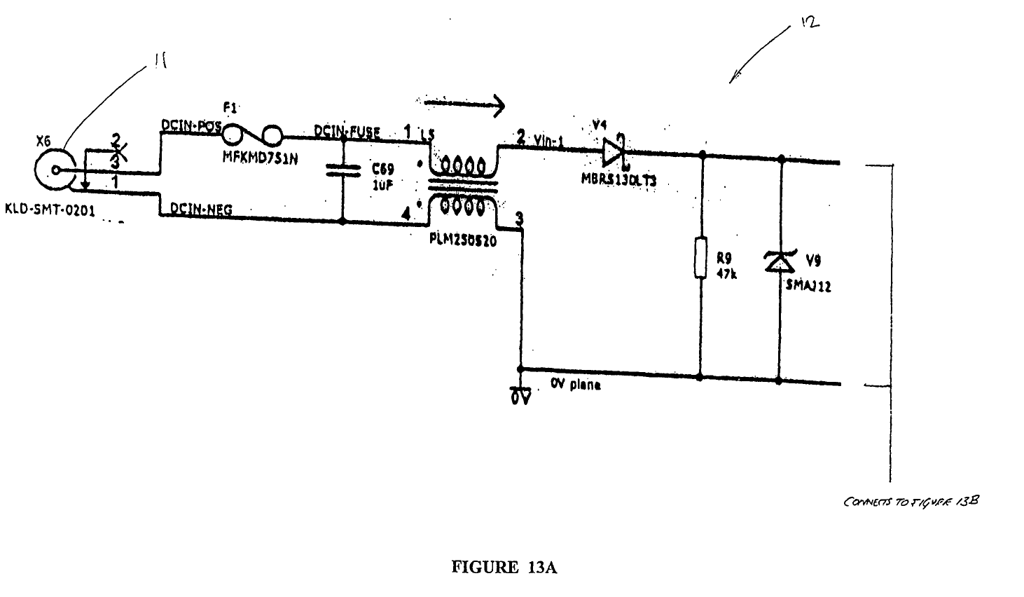

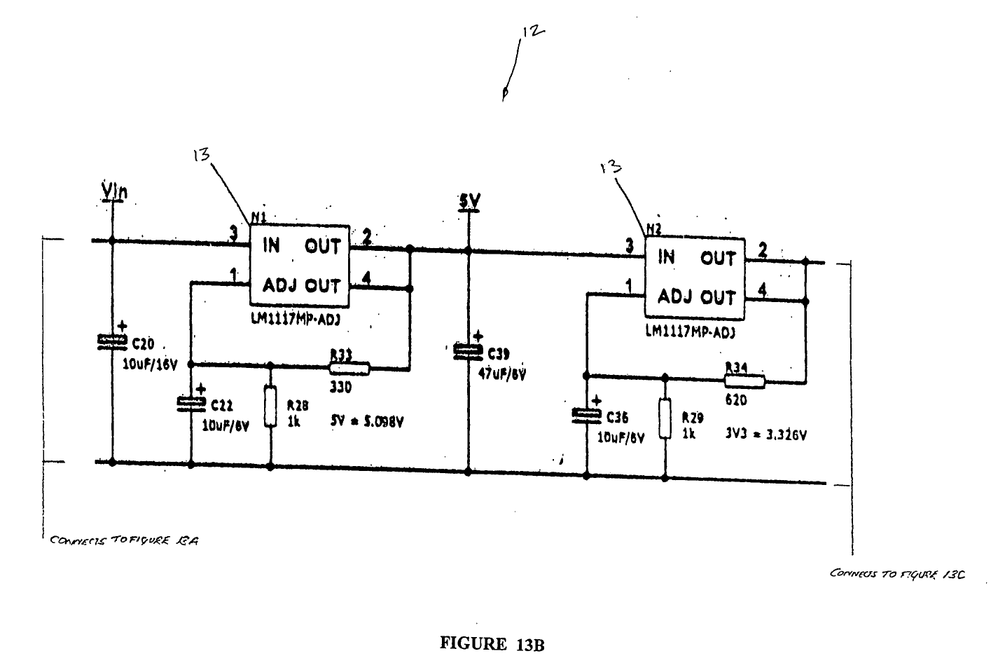

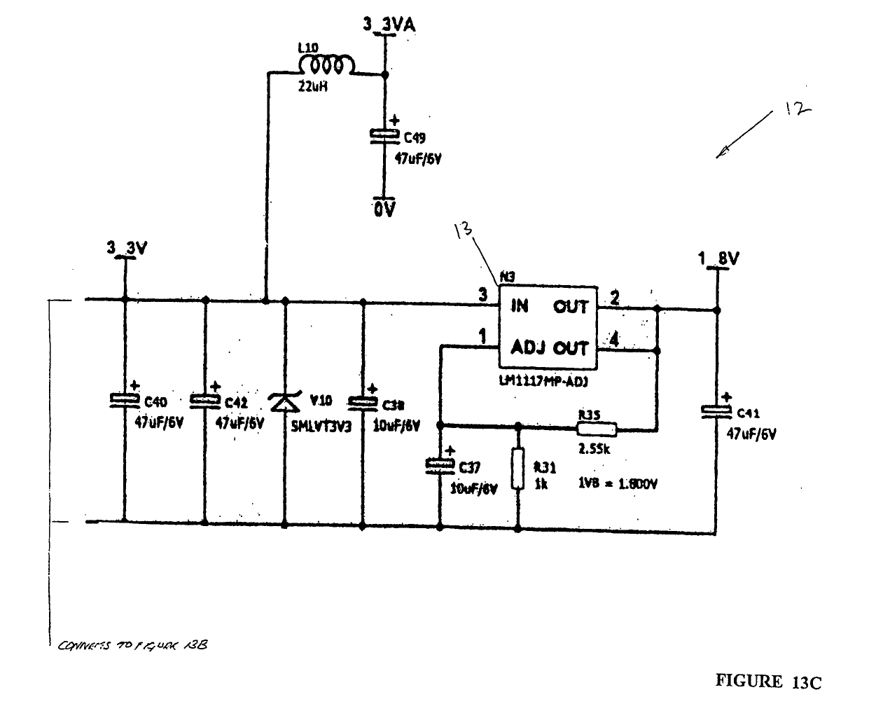

Interface device 4 is powered using the external DC supply 10. Required internal system voltages are derived from an internal power regulation circuit 12 from the supply 10 using linear regulators 13 (National Semiconductor LM1117). A 7.5V DC supply from the power supply 10 is provided to a socket 11, as shown in FIGS. 13A, 13B and 13C.

Host/Console/Telephone Interface

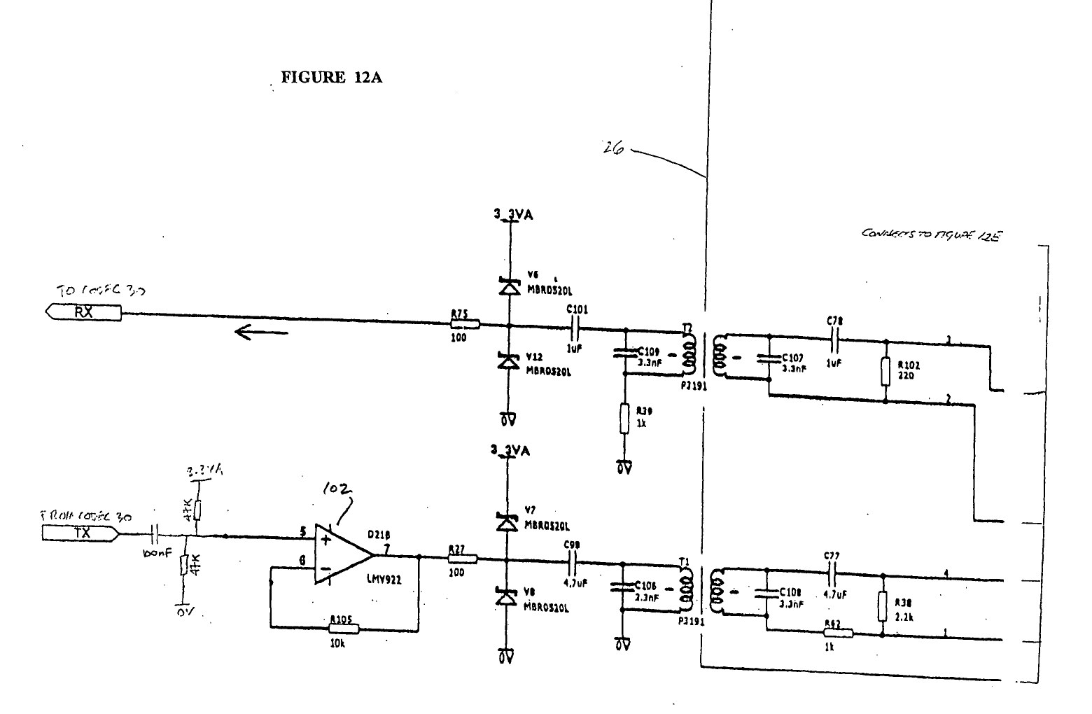

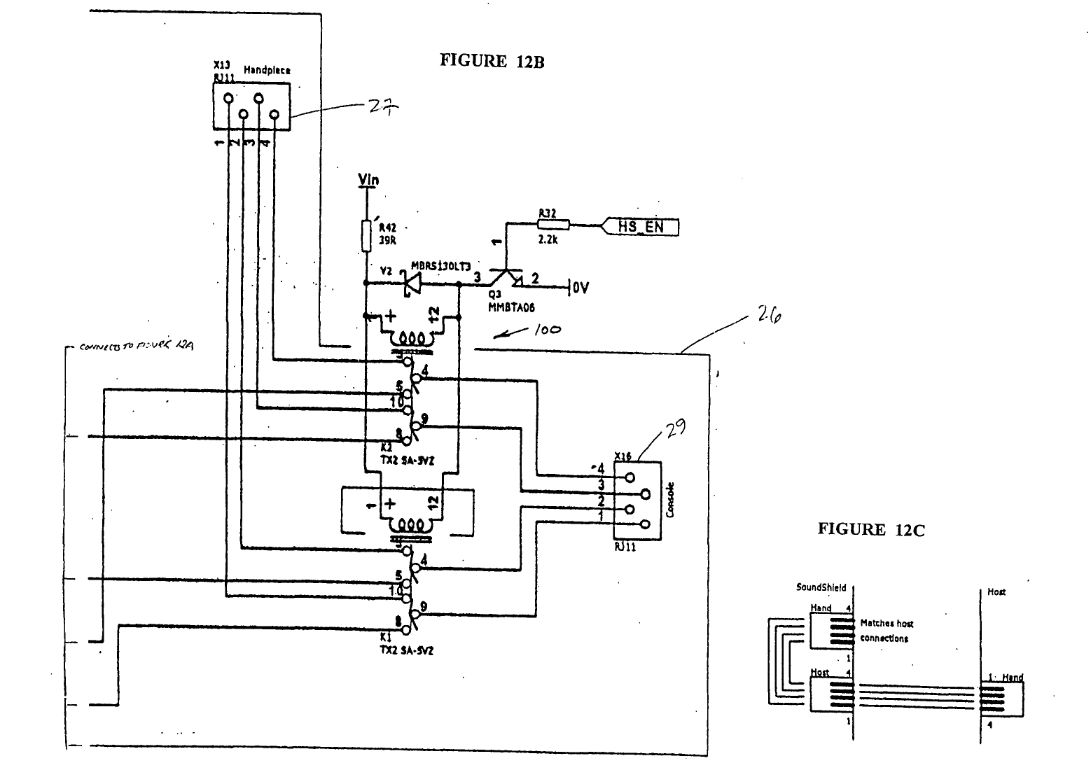

The casing 15 includes input jacks 27 and 29 to provide coupling to the headset 6 and telephony device 8. To maintain compatibility with the majority of telephony devices, the jacks 27 and 29 comprise four position, four contact RJ11 type based on FCC-68 specifications which are used for host and handpiece interfaces. FIGS. 12A, 12B and 12C show typical circuit connections for the jacks 27 and 29.

The existing handpiece from the host can be connected to Interface device 4 and selected for use by a push button control. During power failure, connection is maintained between the host and its hand-piece to allow continued operation of the telephone system. When power is available and the handpiece is not selected, the headset will be connected, via Interface device 4 to the host.

In the arrangement shown in FIG. 12B, a transformer 100 is used to isolate the device 4 allowing compliance with Australian and International safety requirements.

The two conductors that connect the handpiece receiver to the host will be called the receive pair. The two conductors that connect the handpiece microphone to the host will be called the transmit pair. A DC shunt is connected across the receive pair to present a load similar to a handpiece to the host. The interface device 4 receive input is AC coupled and incorporates some filtering and protection components (clamping for large signal inputs and filters for high frequency attenuation). Signal level presented to the analogue to digital converter (ADC) input is adjusted within the CODEC 30 analogue front end (The CODEC 30 is configured by the MCU 22 which stores configuration information in internal EEPROM 24).

A DC shunt is provided across the transmit pair to simulate the presence of an electret microphone (some hosts sense the presence of a headset by the microphone supply current). The interface device 4 transmit output is also AC coupled and incorporates protection and filtering components. The CODEC 30 output is buffered using an op-amp 102 (LMV922 or equivalent) that drives the isolation transformer, providing signal for the host input. Transmitted level is controlled using an attenuator in the CODEC 30 analogue front end. The CODEC 30 can accept input signals up to 955 mV_{RMS} and generate signals up to 1.08V_{RMS} at its output.

Headset Interface

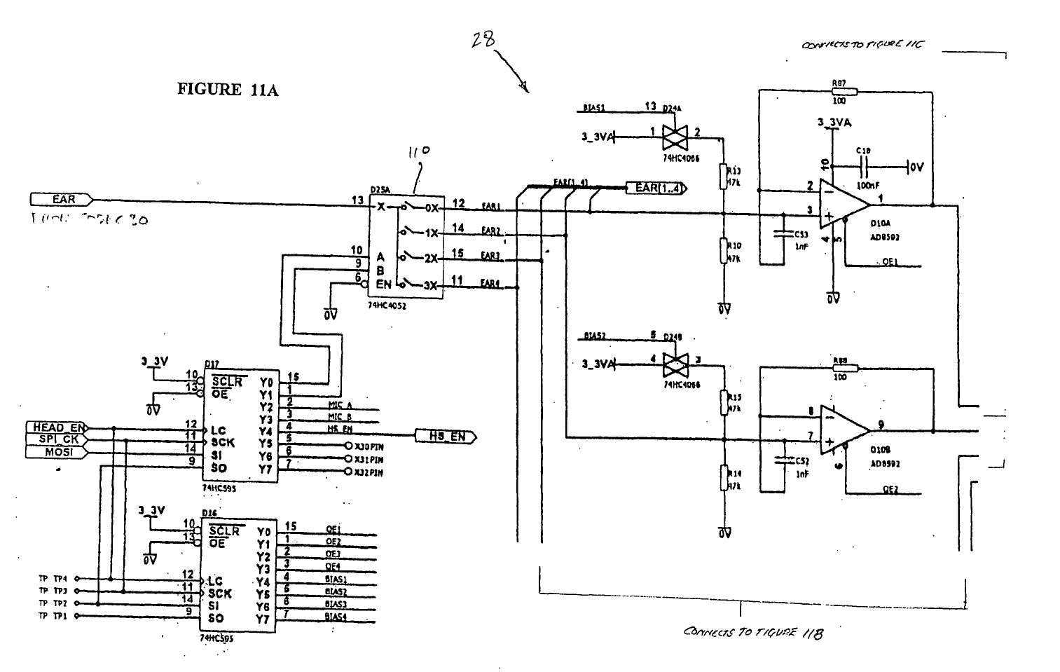

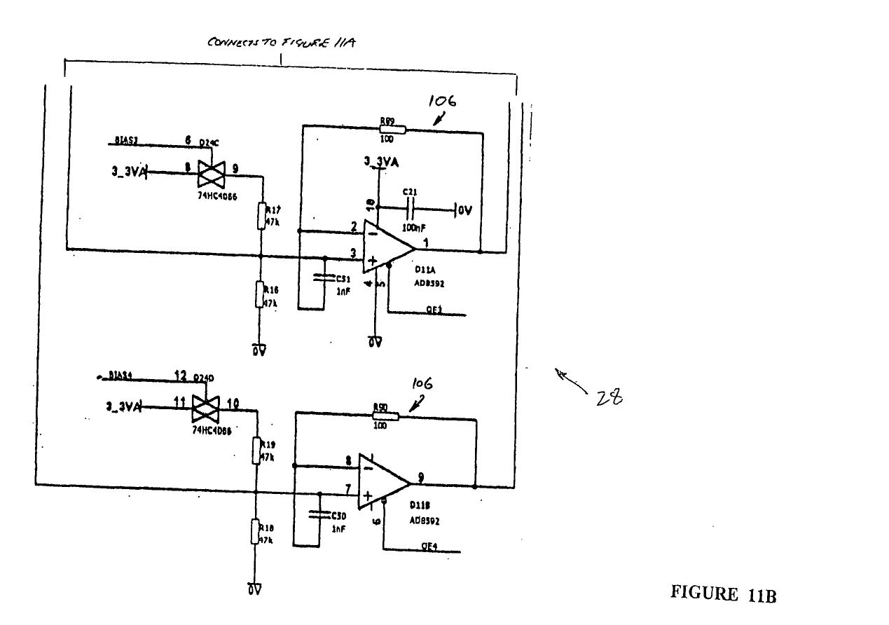

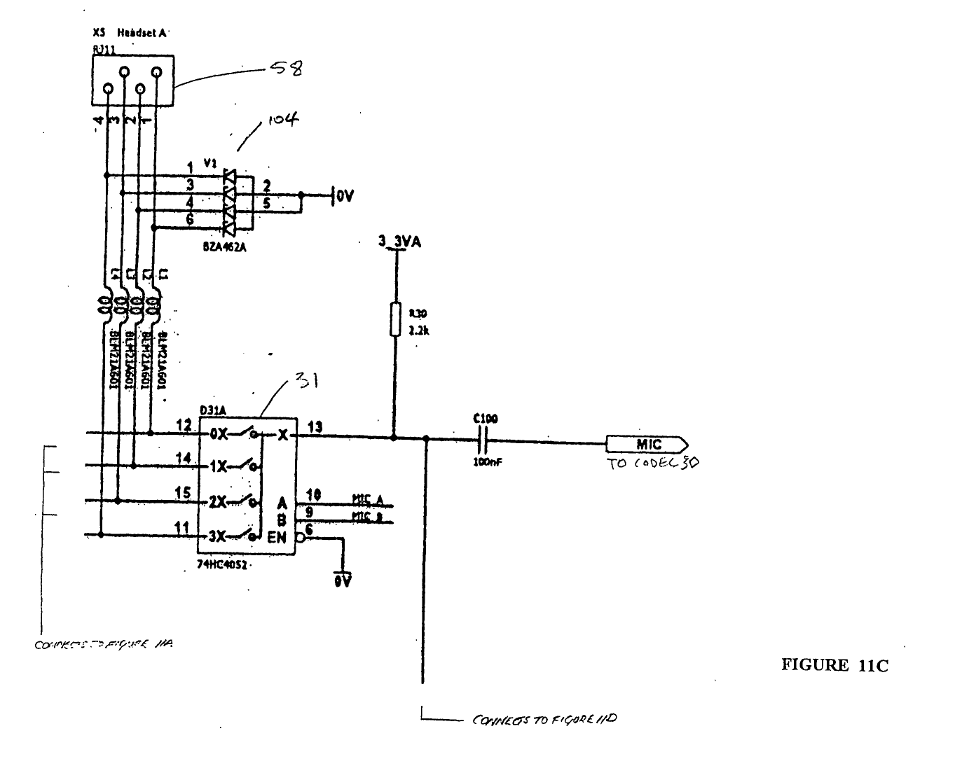

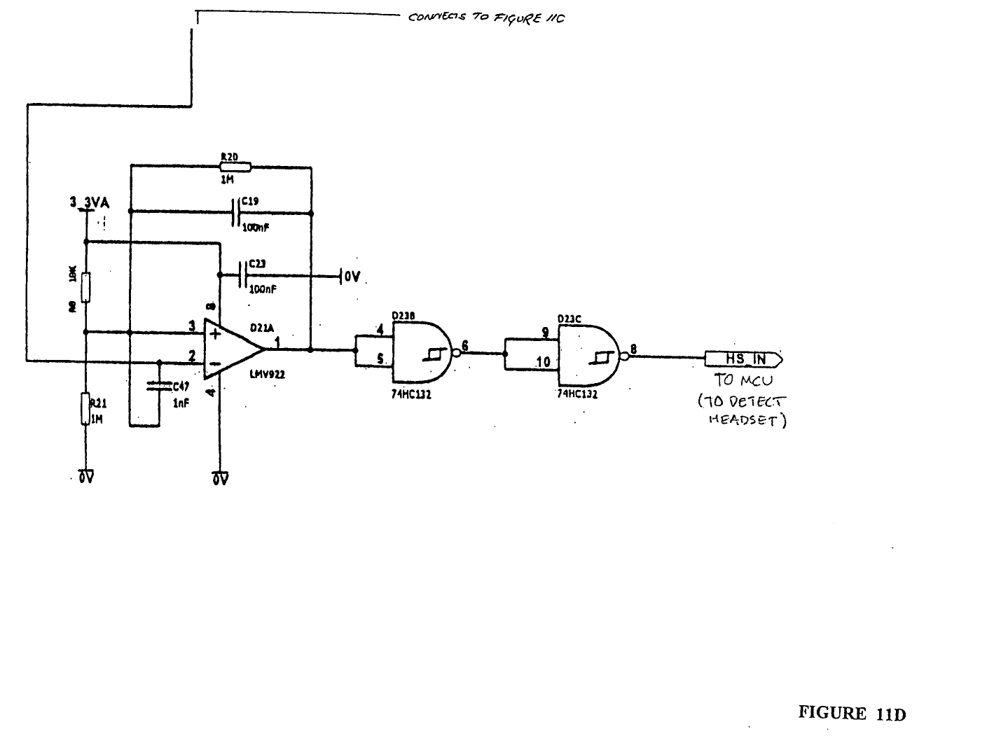

FIGS. 11A, 11B, 11C and 11D show a circuit implementation for the interface 28. To maintain compatibility with the majority of telephony headsets, modular connectors (Four position, four contact (RJ11 type)) based on FCC-68 specifications are used for the headset interface jack 58. Transient suppression is provided for each conductor using Transient Voltage Suppression diodes array 104. Ferrite chips perform high frequency filtering for each conductor, as shown in FIG. 11C. Headset connection arrangements vary somewhat between manufacturers so a method of configuring the connector pin functions is provided. Each pin can perform the function of earpiece driver, earpiece return, microphone input or microphone ground reference. The pin function is under software control and is determined by the headset type that has been selected, as described above. The earpiece transducer is connected in ‘bridge tied load’ fashion although only one of the connections is actively driven.

The device 4 supports electret microphones and provides 3.3V microphone power via approx 2.5 KΩ. Input signal path is switched using an analogue multiplexer 110 (Industry standard 74HC4052) after which the signal is AC coupled to the CODEC microphone input as shown in FIG. 11C. Microphone signal amplification is performed within the CODECs analogue front end. A 26 dB pre-amp is activated for microphones with low output level.

Headset connection is detected by monitoring the microphone current. As shown in FIG. 11B, op-amps 106 are configured as integrating comparators and are used as the detector. Its output drives schmitt input logic that provides sharp transitions on connection and removal of a headset. The detection output is used by the MCU 22 to control entry into power save modes and by the DSP 20 so it can determine the difference between a quiet environment and no headset.

As shown in FIG. 11A, the circuit includes earpiece drivers in the form of low output impedance op-amps 108 (Analogue devices AD8592 or equivalent) that have enable controls. When disabled, the outputs become high impedance and thus the pins they are connected to can be used as inputs. The amps are configured as unity gain buffers so they have negligible effect on the signal level presented to the earpiece. The output impedance of the amplifiers is low compared with the earpiece transducer so minimal voltage division between the source (amp) and load (earpiece) is experienced.

Output signal routing is performed using an analogue multiplexer 31. The mux impedance does not affect signal level since it is driving an high impedance amplifier input.

An analogue switch that ties the amplifier input to half the rail voltage when activated provides bias for the earpiece pins. When the analogue switch is not activated, the amplifier input is tied to ground so the output will present a low impedance ground to the microphone.

Core Digital Section

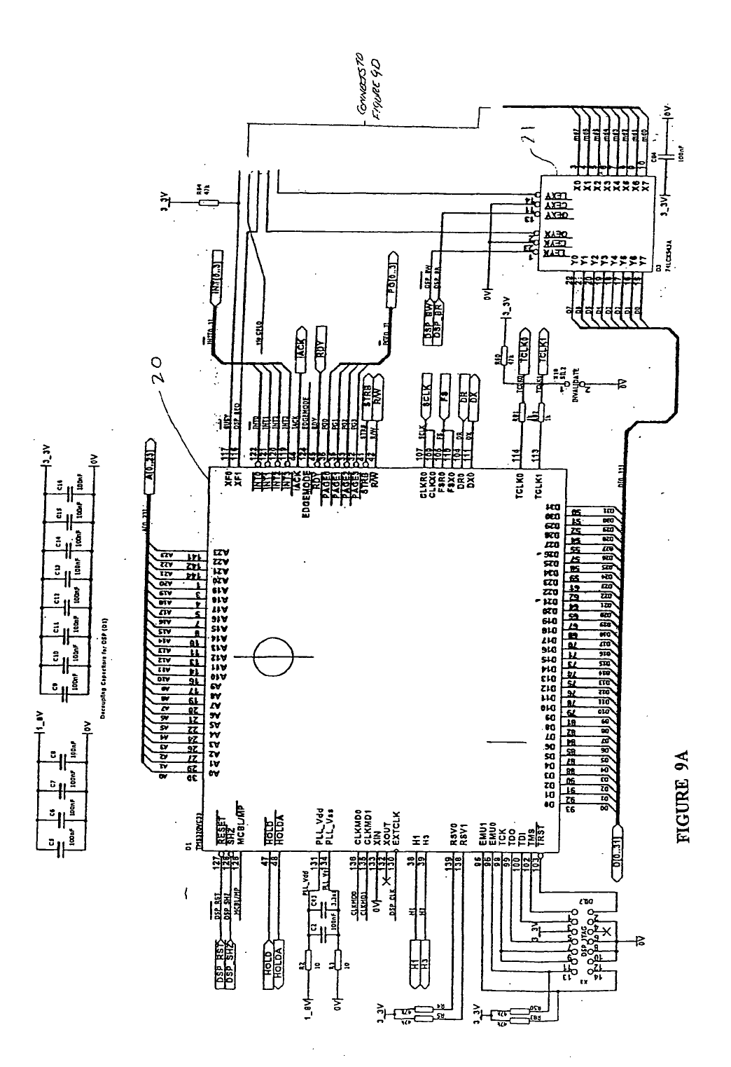

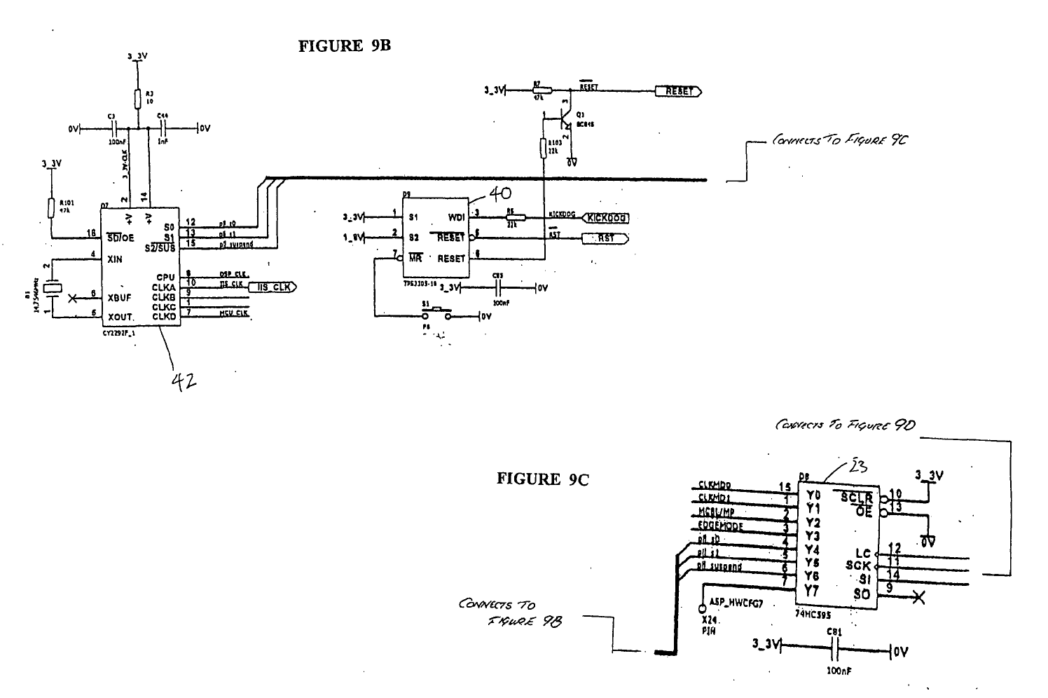

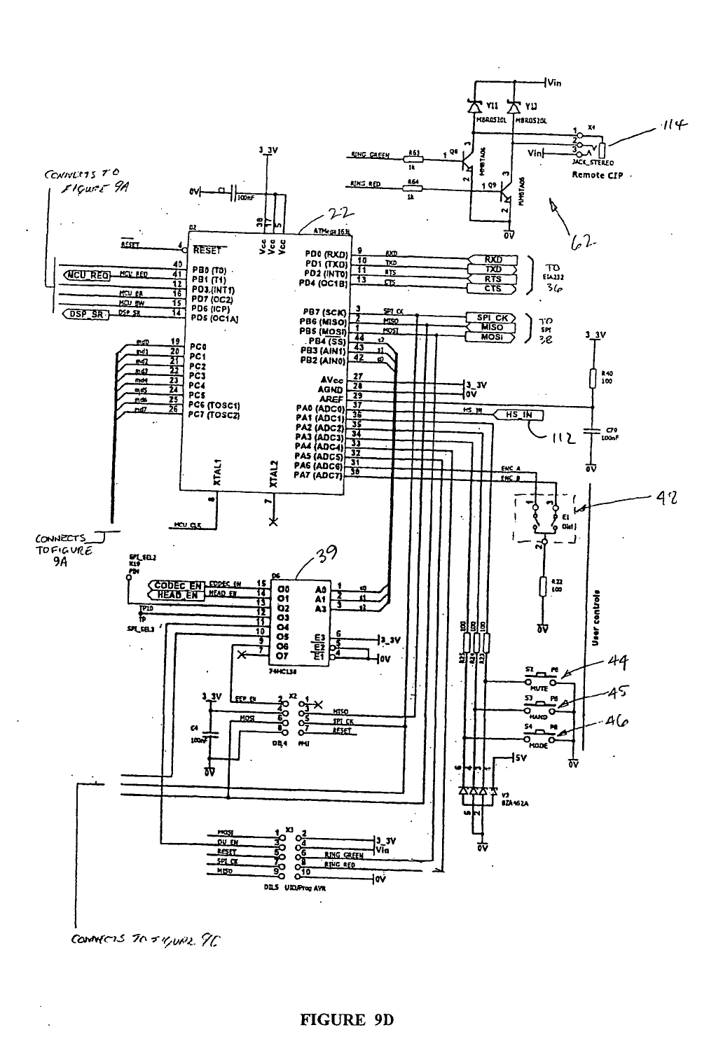

The main digital processing circuitry is shown in FIGS. 9A, 9B, 9C and 9D which join as shown.

Digital Signal Processor

The circuit includes a high performance floating point Digital Signal Processor (DSP) chip 20. The selected DSP 20 is normally clocked at 60 MHz and executes up to 60 million instructions or 120 million floating point operations each second which allows up to 7500 instructions or 15000 floating point operations each 125 us sample period. The DSP software uses part of this processing resource. Part is used by management and configuration utilities.

The DSP 20 is normally configured to operate in microcontroller mode which means it 30 uses an internal boot-loader to load an application from external memory after it has been reset (see Microcontroller (MCU) 22 description below).

After boot and configuration, the DSPs primary function is to receive audio samples from the CODEC 30 via an high speed serial data interface (125 interface), manipulate each sample and re-transmit it some time later (the signal treatment code introduces a delay between input and output of a sample) via the same serial interface.

Specific tasks of the DSP 20 include:
Near and far end speech detection.
Compander based noise reduction for the signal received from the host.
Automatic control of received signal level.
‘Shriek’ detection and suppression.
Received signal level control (limiting).
Clamping of signal peaks that exceed the limiter response times.
Earpiece signal level control determined by user volume setting.
Earpiece signal tone control determined by user tone setting.
Frequency response modification of the earpiece signal to correct headset response.

All these tasks are performed by software executing on the DSP 20. They are listed here to allow understanding of the purpose of the DSP 20.

Sample Data Transfer

Data is transferred between the DSP 20 and CODEC 30 using a high speed synchronous serial interface that partly conforms to the I²S (Inter-IC Sound) defacto standard. Samples are transferred in 32 bit frames consisting of 2, 16 bit samples. The interface is bi-directional so each 125 us period, 32 bits are transferred from the DSP 20 to the CODEC 30 and 32 bits from the CODEC 30 to the DSP 20. The bit clock is set to 256 kHz.

The samples coming from the CODEC 30 for processing are of the headset microphone and host receive (this would be driving the handpiece receiver if Interface device 4 was not in use)signals. The samples sent to the CODEC 30 for output are the processed sample destined for the headset earpiece and a dummy sample (The microphone signal is routed through the CODEC 30 analogue front end to the host transmit connection to avoid conversion delays. The microphone signal is sampled for the speech and background noise detection functions of the signal processing software).

The DSP 20 requires two supply voltages; 3.3V for input/output and 1.8V for the processing core.

Micro-Controller

The Micro-Controller Unit (MCU) 22 (see FIG. 9D) is responsible for system management and control. Specifically it performs the following:
Controls system start-up.
Manipulates Interface device 4 hardware configuration registers.
Manipulates CODEC control registers.
Initialises a communications channel between itself and the DSP.
Provides an asynchronous serial interface to Interface device 4 for maintenance activities.
Manages user and configuration settings.
Monitors and responds to user controls.
Maintains the user display.
Power management of the system.

The MCU 22 contains non-volatile memory for storage of its application and SRAM for temporary data. The application executes directly from the non-volatile memory. EEPROM 24 is provided for storage of data that can be altered during Interface device 4 operation but must be retained when power is not available. The EEPROM 24 is used by the interface device 4 for storage of user settings (volume and tone) and configuration settings (transmit gain, receive gain, headset profile number and acoustic limiter number). It is also used to store initialisation values for the system hardware and passwords for access to maintenance functions.

The MCU 22 contains an internal watchdog timer that is used to ensure correct program execution.

The MCU 22 can be programmed in-system allowing modification of its functionality without replacement of the device.

The MCU 22 utilises a variety of standard and custom communications protocols to configure hardware registers, read push button states, analyse control dial movements, communicate with a maintenance system and exchange data with the DSP 20.

Serial Peripheral Interface

System configuration and part of the user display update is performed using the Serial Peripheral Interface (SPI) 38. SPI devices each have a select input to differentiate them from other devices on the bus. SPI selects are generated using 3 MCU outputs that are decoded by logic 39 (74HC138, 3 to 8 decoder) to provide 8 individual select lines. One of these is not connected to any device to allow selection of ‘no device’.

Connected to the SPI bus 38 are:
Hardware configuration register which
provides control of the PLL clock generator so that different DSP clock frequencies can be selected or allows all clocks apart from the MCU to be disabled,
provides control of the DSP clocking mode,
provides control of the DSP operating mode, and
provides control of the DSP interrupt mode—edge or level triggered.
Headset configuration register which
provides control of the headset pin driver output,
provides control of earpiece and microphone signal routing, and
provides control of the headset driver input biasing.
CODEC 30 which
provides control of all input and output signal routing, gain and attenuation blocks for all inputs and outputs and muting of inputs.
The displays 53 and 54
Serial EEPROM which
allows read/write access to an external EEPROM.
   Universal Asynchronous Receiver Transmitter

The MCUs internal UART is used to provide a partial EIA-232 serial communications interface 36 as shown in FIG. 100. Four of the EIA-232 signals are implemented (TD/RD/CTS/RTS). Signalling occurs at TTL voltages within the system. An external EIA-232 interface chip 36 is required to support signalling at EIA-232 voltages. Provision for the interface chip 36 is made within device 4 but it is not normally installed since the interface is not required during normal operation. A header can be provided for access to this port during manufacturing tests and maintenance.

Inter Processor Communication

As shown in FIG. 9A, the IPC buffer 21 is used for 8 bit parallel data to exchange between the DSP 20 and MCU 22. This interface allows high speed transfer of information between the devices which is required to allow maximum DSP time for signal processing tasks. Each device controls a request signal to alert the other of pending exchanges. A common ˜BUSY signal is used for hand-shaking. The protocol is described in the software portion of this document.

The MCU 22 can reset or shutdown the DSP 20 as required. When the DSP 20 is shutdown, its address, control and data lines may be driven by an external device. When the DSP 20 is reset, it retains control of the buses but does not execute any code. MCU 22 control of DSP 20 operation is achieved using two control signals, DSP_SR (DSP Shutdown/Reset) and MCU_REQ (MCU Request). DSP_SR is dedicated to state control. MCU_REQ is shared with the MCU/DSP communications interface. If DSP_SR is asserted, the DSP will be reset. Assertion of MCU_REQ will shutdown the DSP. If DSP_SR is not active, MCU_REQ performs its normal function.

User Interface

FIG. 90 shows the mute button 44, handset button 45 and mode button 46 coupled to inputs of the MCU 22. The dial 48 is also connected to an input of the MCU 22. The MCU 22 reads the state of the user interface controls many times a second to determine whether the user has operated a button or rotated the adjustment dial 48. The software description explains what happens when an operation is detected. The dial 48 includes a rotary encoder for signalling the MCU 22 in response to movement of the dial 48.

MCU interaction with the user display is described in the User Display section.

Other Inputs

The headset presence detection signal (HS-IN) on the terminal 112 is connected to a MCU input. The MCU 22 is clocked at 3.6864 MHz which allows a wide range of UART communication speeds whilst retaining most of the allowable processing speed. Because of its RISC architecture, the MCU 22 can perform up to 3.6 million instructions per second (MIPS).

As shown in FIG. 9D, the circuit may include a remote call indicator circuit 62 to enable a call centre monitoring system (for example) to tell whether the user of the device 4 is on a call. If an appropriate signal line is plugged into the jack 114, a call indicator signal is provided for input to the MCU 22.

CPLD

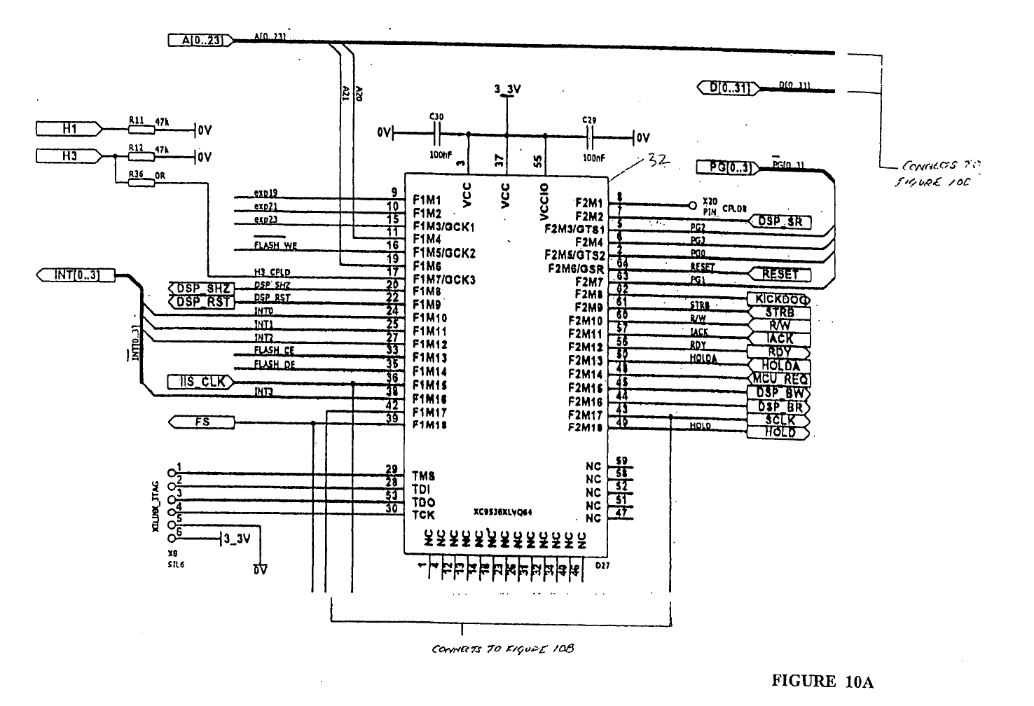

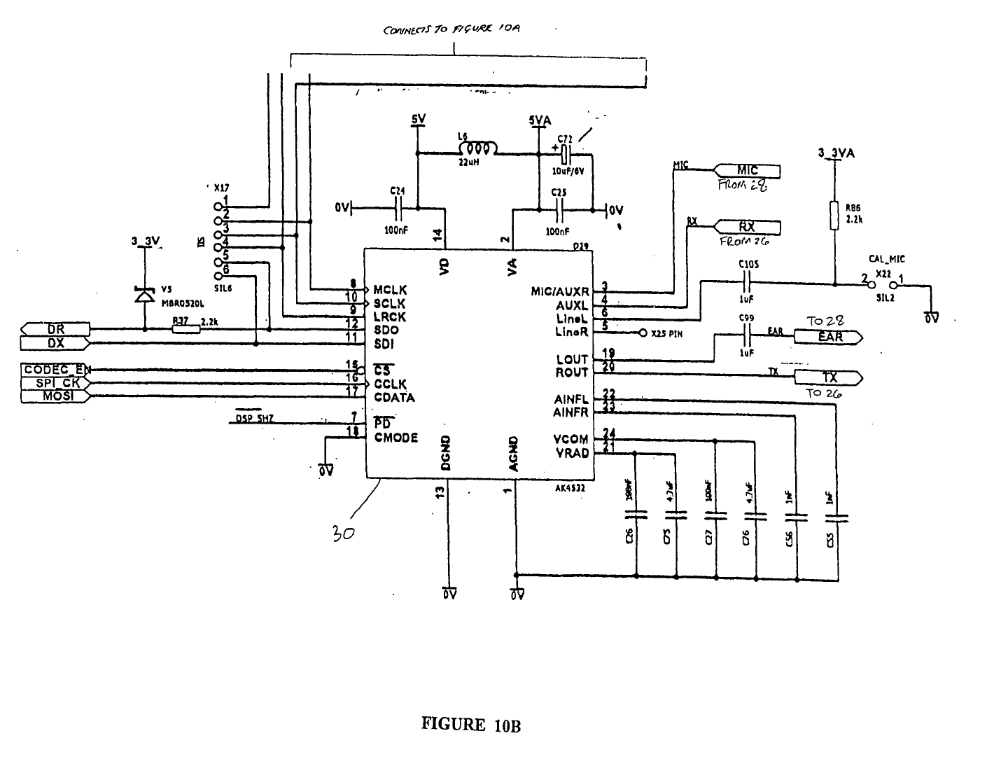

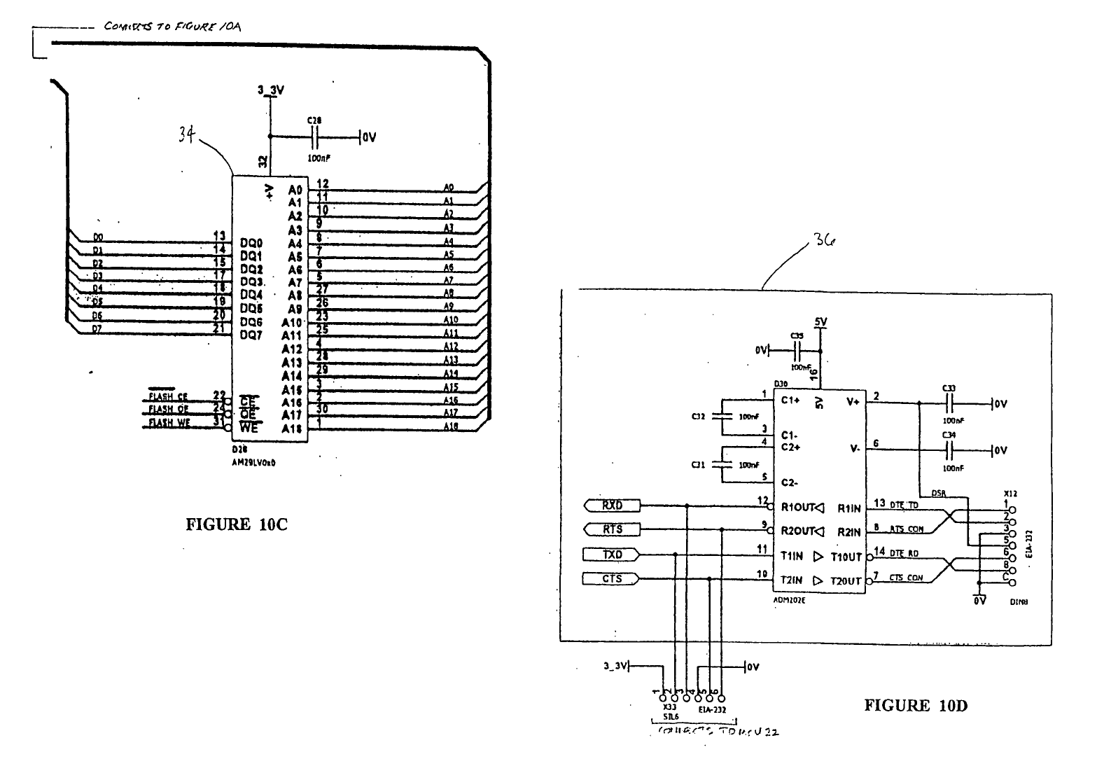

The Complex Programmable Logic Device (CPLD) 32 (XILINX XC9536XL) is used to perform many mundane digital tasks such as address decoding, clock division and system state control. A typical circuit implementation is shown in FIG. 10A.

System State Control

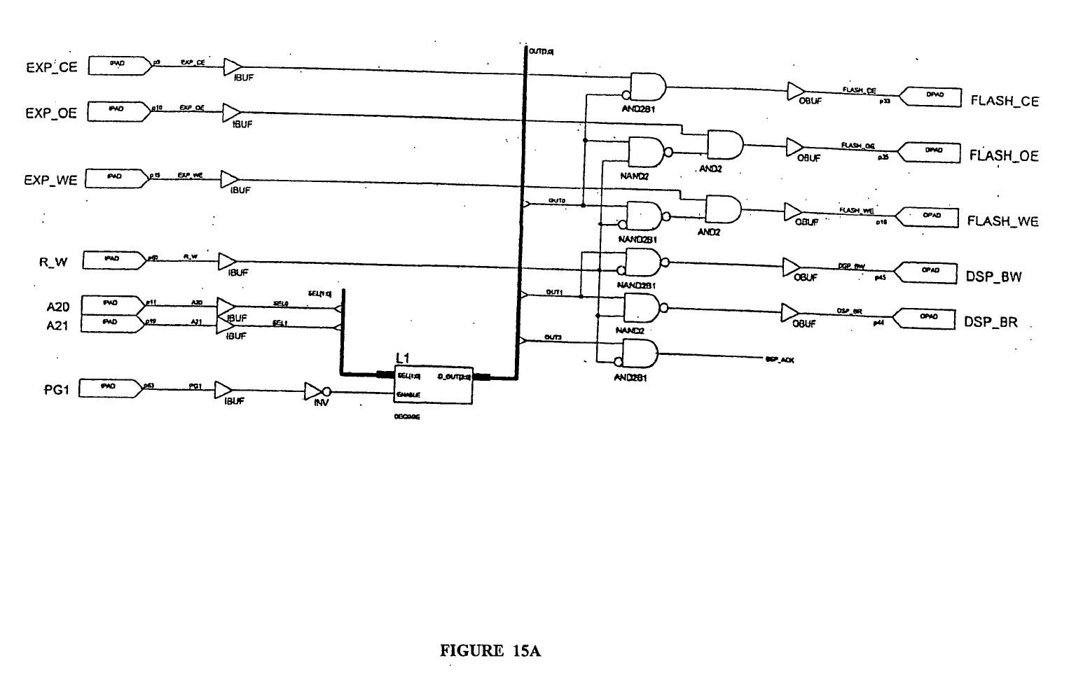

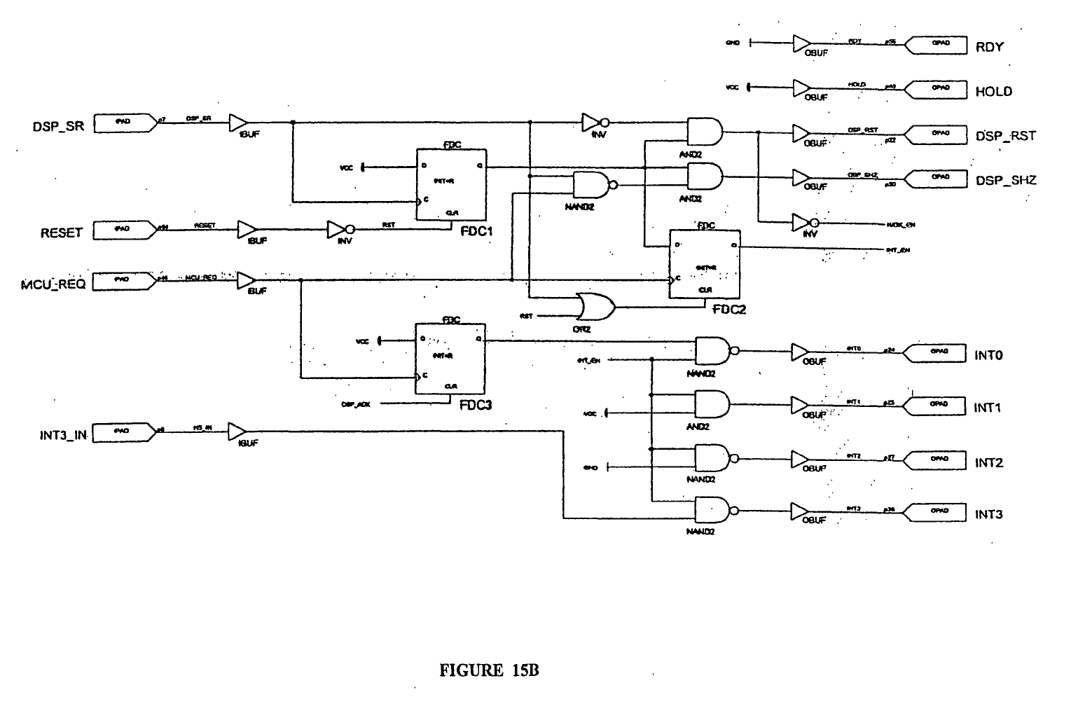

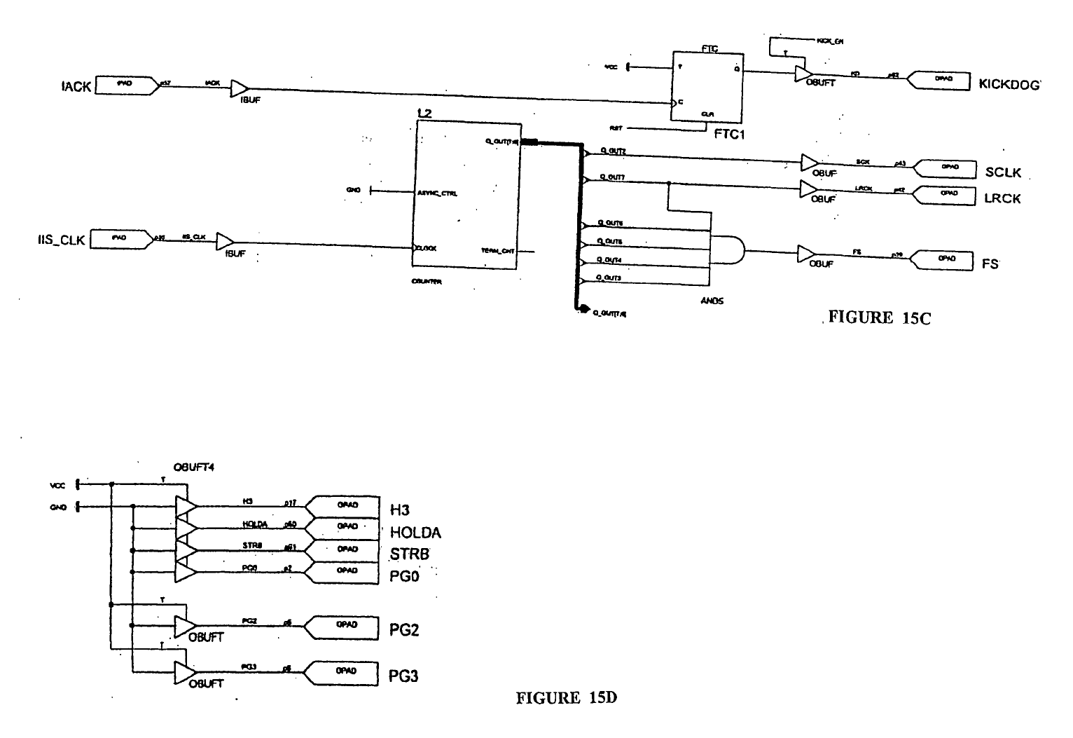

The CPLD 32 manages the state of a number of system signals. FIGS. 15A, 15B and 15C show a typical circuit implementation for the CPLD 32.
Interrupts
At reset, the DSP 20 interrupt lines are set to values that cause the DSP 20 boot-loader to load an application from a specific address. The system memory containing Interface device 4 application loading code is located at this address.

After the DSP 20 has booted and during the configuration phase, the DSP writes to a specific address the CPLD 32 decodes as an interrupt enable signal. This configures the DSP 20 interrupts for their normal roles.
DSP Reset & Shutdown
After a master reset (hardware reset button, power failure or reset by the system supervisory chip), both DSP shutdown and reset signals are asserted by the CPLD. Logic is provided to allow the MCU to control assertion of both these signals in order to start and stop DSP operation as required.
Other signals
The CPLD 32 controls other DSP inputs (˜RDY and ˜HOLD) as required for proper operation. These are held in one state during operation of device 4 and not controlled. Changes to the CPLD internal logic would allow control of these signals if ever required.
   Address Decoding

The DSP address space is sub-divided by the CPLD 32. Addresses in combination with some control signals are decoded to provide the following facilities:
Generation of select, read and write signals used by the DSP 20 for accessing the Flash memory.
Generation of buffer read and write signals used by the DSP 20 for inter processor communications.
Generation of an interrupt acknowledge signal that clears latched interrupts.
   Watchdog Control

Being processor based, device 4 requires some system supervision. The supervisor for the DSP monitors both its supply voltages and provides a watchdog timer 40, as shown in FIG. 9B. The timer must be reset periodically by toggling the watchdog input of the supervisory chip 40. This is achieved using a DSP signal that operates a toggle flip-flop within the CPLD to produce a square wave signal to the supervisor. When the DSP is shutdown, the CPLD output to the supervisor is disabled (high impedance), disabling the watchdog and preventing system reset due to watchdog timeout.

Timing Generation

The CPLD 32 divides a 2.048 MHz reference clock signal from clock chip 42 to produce the required signals for the CODEC/DSP sample data interface, as shown in FIG. 9B. It generates the serial data clock at 256 kHz and the channel clock at 16 kHz. An 8 kHz frame synchronisation pulse for the DSP serial interface is also generated.

Memory

As shown in FIG. 10C, the interface device 4 utilises flash memory 34, the capacity being in the range 1 Mbit to 4 Mbit for most of its non-volatile storage requirements. DSP application code and configuration data are stored in non-volatile flash memory 34 and loaded into SRAM inside the DSP at system start-up or, in the case of configuration data, as required by the application. All high speed static RAM (SRAM) is contained within the processing chips which minimises off chip memory accesses and allows faster program execution. The DSP contains 34 k words of SRAM, all of which can be accessed twice each DSP clock cycle. The MCU contains 512 bytes of SRAM. Provision for an external serial memory could be made to allow for storage of data customised for a particular user. The content of this memory is discussed in the DSP software description.

Clock Generation

As shown in FIG. 9B, the circuit includes a clock 42. In the illustrated arrangement, the clock 42 is a triple PLL IC (Cypress Semiconductor CY2292F). It uses a 14.7456 MHz reference crystal to generate the following:
2.048 MHz I²S master clock.
3.6864MHz MCU clock.
15/12/9 or 6 MHz DSP clock (determined by the hardware configuration register). The DSP can multiply this by 5 using its own PLL circuit producing a range of operating speeds between 75 MHz and 6 MHz.
   User Display

The interface device 4 user display consists of three elements:

1. LED Bar Display 53

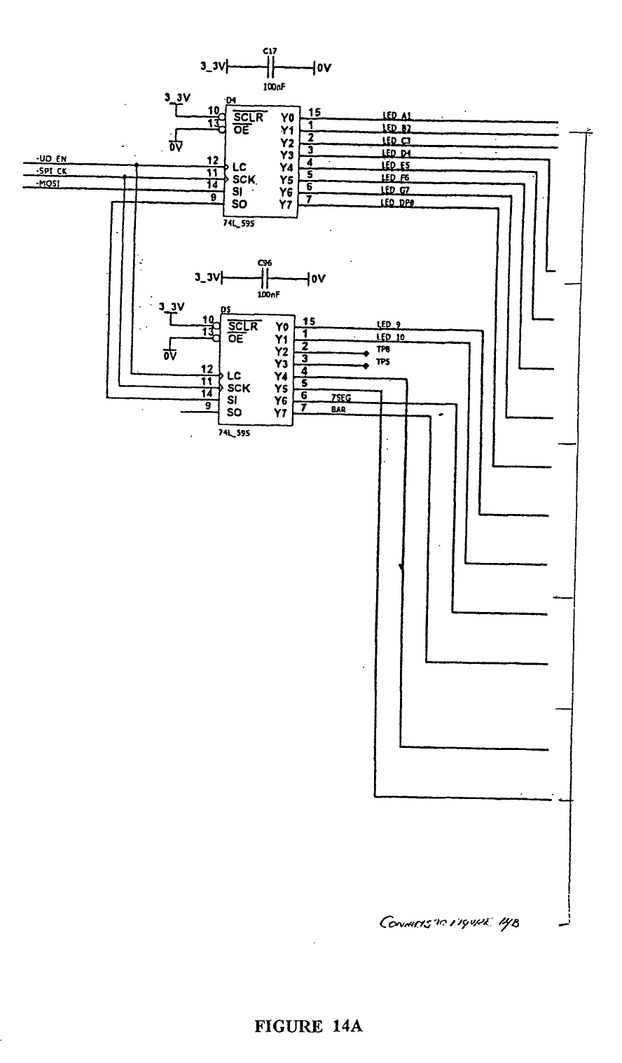

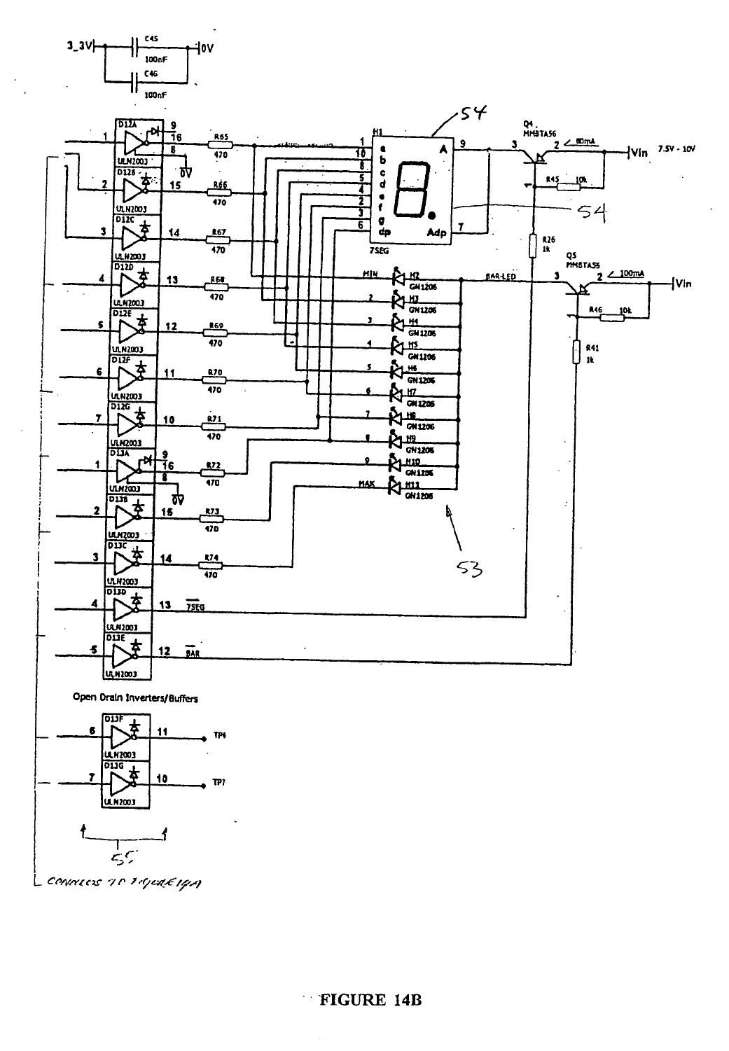

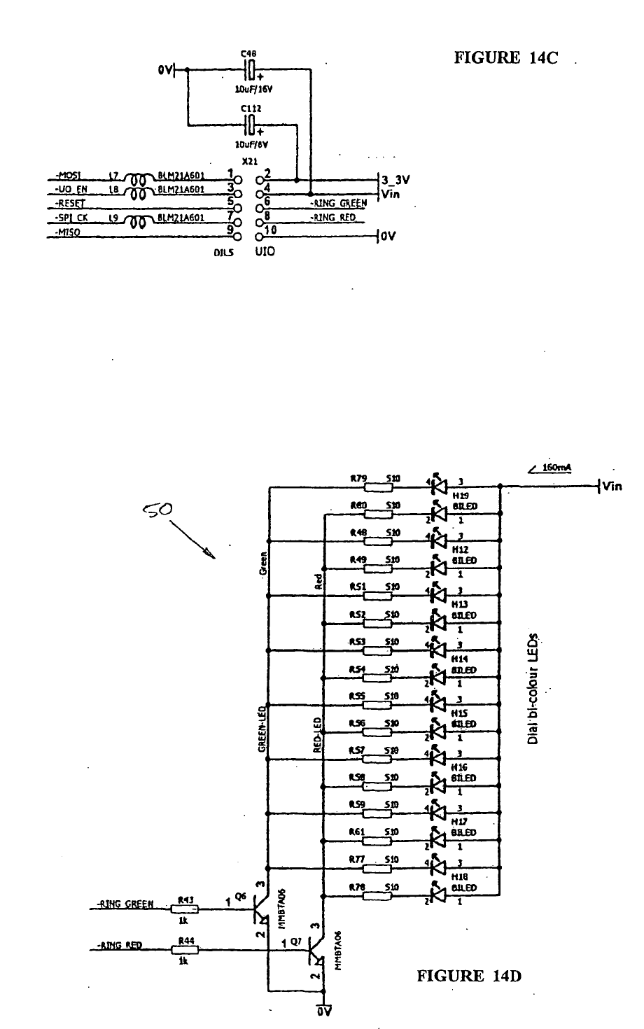

As shown in FIG. 14B, the display 53 consists of 10 discrete 1206 (3.2L×1.6W×1.1T) style chip LED segments 53. These are high efficiency green LEDs. The Bar segments are powered directly from the DC supply input (7.5V nominal) and when active, each is current limited to 10 mA using series resistance. A light pipe is used to control light dispersion for the Bar.

2. LED Digit Display 54

As shown in FIG. 14B, the display 54 has a single 7 segment LED display 54 (11L×7W×5T, common Anode) that includes a decimal point. Preferably, a green, high intensity model is used. The display 54 is powered directly from the DC input and when active, each segment is current limited to 10 mA using series resistance.

3. LED Light Ring 50

As shown in FIG. 14D, the Ring 50 consists of 16 discrete bi-colour 3025 (3.0L×2.5W×1.1T) style chip LEDs. The LEDs are high intensity red/green combinations allowing red, green or yellow light to be produced. The Ring LEDs are powered directly from the DC supply input and when active, each red is current limited to 10 mA and each green to 15 mA using series resistance. A light pipe is used to control light dispersion of the Ring.

The MCU 22 is operable to update the user displays. Individual MCU outputs are provided to control each colour of the Ring 50. When driven high, these outputs provide base current for NPN switching transistors that sink current for the LEDs. When the MCU output is low, no base-bias voltage is available and the transistor collector-emitter paths remain high resistance. LEDs of the same colour are driven in parallel so the green transistor must sink 240 mA and the red transistor 160 mA, when activated by the MCU.

The Bar and Digit displays are multiplexed. Each is updated 50 times a second via the MCU SPI (100 Hz update frequency for both). SPI clock frequency for the user display is 920 kHz so display data transfer requires less than 20 us. PNP switching transistors are used to activate the supply for either display element. The latching shift registers that control each LED segment provide base control for each switching transistor. Data shifted into the registers alternates between Bar and Digit data. When Bar data is present, the transistor controlling supply for the Bar segments is biased on and the other biased off. When Digit data is present, the transistor controlling supply for the Digit segments is biased on and the other biased off.

To turn each transistor on, the base must be at least 0.7V lower than the emitter (the emitter is connected to the DC input which is nominally 7.5V). To turn each transistor off, the base must be held within a few millivolts of the emitter. These states are achieved using open collector, inverting buffers to drive the transistor bases. Each transistor's base is connected to its emitter using bias resistors. When the buffer is inactive (the data register is driving the input low), the buffer output is effectively open circuit and transistor base voltage approaches the emitter voltage due to the bias resistor. The transistor is off, disabling its display element. When the buffer is active (input is driven high by the data register), the buffer output provides a low resistance path to 0V which pulls the base low causing the transistor to turn on (saturate). The display element is active. As shown in FIG. 14B, each display segment is driven using an open collector inverting buffer 55 to isolate the shift registers from the DC input voltage which exceeds the registers operational parameters.

Software

The software includes two main categories; (1) Configuration and Control and (2) Signal Processing. These are described below.

Configuration & Control

Responsibilities are split between the MCU and DSP. They are listed below according to the host processor:

MCU

Initialisation of system hardware.
Communication of data to the DSP.
Provide serial communications for a maintenance interface.
Recall and implementation of user settings.
Interpretation of and action on user control changes.
Maintenance of the user display contents.
   DSP
Recall of selected headset and limiter configuration data.
Communication of data to the MCU.
Erasure and update of the Flash memory contents.
Serial communications management (via IPC).
Control access to administrator and developer commands.
Manufacturing test control.
   MCU Description

FIG. 5 diagrammatically shows the interaction between the various MCU software modules.

Initialisation Process

After power is applied to Interface device 4 and its internal power rails reach adequate levels, the MCU will begin executing code.

Internal peripherals and MCU ports are initialised first. This incorporates defining which pins are inputs, which are outputs and the initial state of each pin; high or low for outputs or pull-up for inputs. Peripherals initialised are the UART, timers and watchdog.

Next, the MCU restores its last internal state from on-chip EEPROM then outputs a software identifier string to the maintenance port to indicate it has started and configured its internal hardware.

Following this, the SPI (Serial Peripheral Interface) sub-system is initialised with each SPI devices timing information, data size and latch polarity passed to the SPI software module.

The interface device 4 hardware configuration is then loaded from EEPROM and sent to the hardware configuration register using the SPI.

Next, the user and operational settings are loaded from EEPROM. These include volume, tone, transmit level, receive level, headset type and limiter type. The settings are stored in MCU RAM where they are available for manipulation by the MCU as a result of user interface operations or DSP via the MCU. Any changes are immediately stored in EEPROM so they are available in case of power failure.

Next, the MCU creates its end of the Inter Processor Communications (IPC) channel in preparation for booting of the DSP. The DSP is taken from shutdown to reset state by the MCU which also enables the CODEC in preparation for its configuration.

The CODEC control module (CDC) is initialised which involves reading all the CODEC register values from EEPROM and using the SPI to load them into the CODEC.

Finally, the DSP is taken from reset to run state and it begins its boot procedure.

Inter Processor Communications (IPC)

The MCU transfers information to the DSP using the IPC sub-system 21. Transfers occur one byte at a time and are controlled using two signals; MCU Request (MCU_REQ) and Busy (˜BUSY). ˜BUSY indicates the state of the IPC communications channel and is monitored and controlled by both MCU and DSP.

For the MCU to initiate a transfer, ˜BUSY must be high. If the DSP is driving it low (˜BUSY is driven low by either DSP or MCU. If neither device is driving it low, it is pulled high by a resistor connected to the positive rail), the MCU must wait until the DSP is no longer busy. If ˜BUSY is high, the MCU may initiate a transfer by loading a byte into the transfer buffer (the transfer buffer is a latching, bi-directional buffer with independent latch and output enables for each direction. The MCU can read and write data without affecting DSP reads and writes) then asserting MCU_REQ. The DSP will respond to this request by asserting ˜BUSY. It will read data from the transfer buffer some time later. The MCU may remove the request immediately as it is latched within the systems CPLD. The MCU cannot initiate a transfer if it is asserting ˜BUSY.

A number of IPC commands are defined to assist in communicating the required information between processors. These are listed in the table below.

| Command | Meaning (MCU initiated) |
|---|---|
| IPC_VOLUME | Contains the current user volume setting. The DSP |
| | should use this volume within the signal processing |
| | module. |
| IPC_STATE | Contains the current states of the Mute and Headset |
| | user controls. The DSP should use the states to control |
| | the signal processing functions. Ie. Don't use |
| | microphone signal if microphone is muted! |
| IPC_RESET | Cause a system reset by stopping the DSP resetting its |
| | watchdog timer. |
| IPC_STATUS | Asks the DSP for its status word. |
| IPC_{—} | Informs DSP the handpiece has been selected and it |
| HANDPIECE | can stop processing speech samples. |
| IPC_HEADSET | Informs DSP the headset has been selected and it must |
| | resume processing speech samples. |
| IPC_YESIAM | Response to DSP initiated IPC_RUTHERE message. |
| | Used during DSP start-up. |
| IPC_ERROR | Response to any DSP initiated message the MCU does |
| | not understand. |
| IPC_{—} | Informs the DSP, the following byte will contain the |
| SET_TONE | user tone selection. |
| IPC_SET_{—} | Informs the DSP the following byte will contain the |
| H_NUM | selected headset profile number. |
| IPC_SET_{—} | Informs the DSP the following byte will contain the |
| L_NUM | selected limiter number. |

Commands initiated by the DSP are detailed in the IPC section of the DSP software description.

Serial Communications

The MCU 22 provides asynchronous serial communications support for maintenance activities as mentioned above. The MCU UART peripheral is used to provide a subset of the EIA-232 communications interface. It is configured to operate at 19200 bps with 8 data bits, 1 stop bit and no parity. Flow control is provided by the RTS/CTS signals. Serial data is received by the MCU 22 and assembled into bytes. On reception of each byte, MCU execution is interrupted and the Serial Receive ISR (Interrupt Service Routine) (SIO_RXIsr) moves the byte from the receive register to a buffer in RAM. Size of the receive buffer is configurable but is set to 8 bytes. After the data has been buffered, execution returns to the interrupted task.

Periodically, the MCU 22 checks whether any data is in the receive buffer. If there is, it partially translates the data to determine what it means. If no other bytes have been translated and the first byte read is a colon ‘:’, the MCU sets a flag indicating it is in command mode and further bytes are to be translated by the command module (CMD) until a complete command has been received and executed. If no other bytes have been read or a command has just been completed and the next byte is anything other than a colon, the MCU assumes it is intended for the DSP and transfers it to the DSP using the IPC channel. The DSP has its own serial command translator that will be discussed in the DSP section.

A special case exists when the DSP has indicated to the MCU it wants to receive all serial characters, even the colon. This is used during binary (XMODEM) transfers of application or configuration data so the MCU does not ‘steal’ any bytes. The DSP must release the MCU from this state when it has completed reception of the data.

Serial transmission is not interrupt driven. When a byte is to be sent, the MCU must wait until the UART transmit register is empty before loading a new value. The transmit register empty status bit is polled until the register is available after which the new data is written and normal code execution is resumed.

User Control Interface

As described above, the user controls consist of three buttons 44, 45, 46 and one multi-function dial 48 which are used as inputs to the MCU 22. The way in which the MCU interprets these inputs is described below. The actions that occur within the software as a result of user operations are described in the command interpretation section which is described later.

The MCU has no operating system or kernel as such. It has a set of jobs it must perform repeatedly: they are contained within a control loop (see FIG. 5). The control loop will only branch to other code if an external event occurs such as arrival of serial data, change of a buttons state or IPC activity. Within the control loop are two functions that monitor user controls and act on changes. The first detects operation and release of buttons. The second detects dial movement. Both functions form part of the User Interface (UI) module.

The button monitoring code, reads the state of the MCU inputs that are connected to the three buttons. If a button is pressed, the input will be pulled low and if released, it will be high. Button de-bouncing begins when a press is detected. For a press to be registered as valid, the button input state must remain constant for <n> successive executions of the button monitoring code. If a change is detected between calls, the count is re-started. The value of <n> is determined by the execution speed of the control loop. It should equate to around 6 milliseconds.

If the same combination is seen an adequate number of times, that button combination is returned and the control loop calls the command interpreter to determine what it means and what action needs to be taken. A flag called MCU_BUTTON_BREAK is set the first time a valid combination is returned and cleared for all following returns of the same combination allowing the control loop to determine how long the combination has been operated. If the same combination is released then re-pressed, MCU_BUTTON_BREAK will be set the first return after the de-bounce period and cleared for all successive returns.

Seven button combinations exist (no buttons operated is not included in the count) although the MCU command interpreter only understands five of these: Mute alone, Headset alone, Mode alone, Mute with Mode (configuration) and Headset with Mode (developer functions). The result of each of these events is described in the MCU command parser section which is described later.

Display Update

The Interface device 4 displays are managed by the MCU 22. The DialMode variable introduced in the User Interface Specification determines what is displayed.

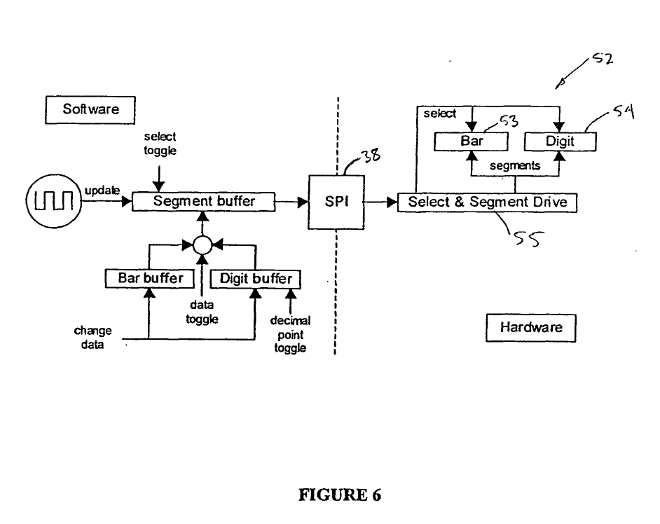

FIG. 6 illustrates how the Bar and Digit displays 53 and 54 are managed. Display update is performed every 10 ms by calling the update function from within a timer interrupt. Each execution, the select bit of the segment buffer is toggled to alternately enable each display. Each execution, the appropriate buffer is copied to the segment buffer which is shifted to the LED driver using the SPI module. Data shifting occurs at nearly 1 Mbit per second to minimise update time. Each <n> executions, the decimal point bit in the digit buffer is toggled. The value of <n> is chosen depending on the flash rate desired.

Modifying the Bar or Digit buffer changes the displayed values. Other modules modify the buffers using SetBarVal/DigitVal functions provided by the UI module.

The Ring indicator is driven directly. Its control signals are connected to the MCU and can be activated or deactivated by changing the state of the appropriate MCU port bits.

Command Interpretation and Execution

The MCU command parser (CMD) understands can interpret commands or data provided from three sources: Maintenance commands received via the Serial interface, DSP commands received using IPC and User commands generated as controls are adjusted.

Serial Commands

Commands received via the serial interface are limited to maintenance activities. These commands are normally preceded by a colon to differentiate them from DSP serial commands. Serial commands are provided to perform the following:
Display MCU registers and memory.
Display the software identification string.
Reset the MCU.
Enable of disable the DSP.
Set registers or memory to a value.
Control the power save state of Interface device 4.
   DSP Commands

Commands received from the DSP are usually updates of system status or settings that result from a maintenance command issued to the DSP. Commands initiated by the DSP are detailed in the IPC section of the DSP software description.

User Control Commands

These consist of both button events and dial movements.

The Button events able to be processed are:
Mute activation/deactivation (ie pressing the mute button 44)
Updates the mute status indicator and informs the DSP (using IPC) of the new mute state. Updates a CODEC register bit used to mute the microphone input using the SPI module.
Headset activation/deactivation (ie pressing the headset button 45)
Updates the interface device 4 in-use indicator and informs the DSP of the new state. Using the SPI, updates the headset enable (HS_EN) bit in the headset configuration register to connect or disconnect interface device 4 from the host.
Dial mode change (ie simultaneous pressing of buttons 44 and 46)
Updates the DialMode variable which indicates how the dial movement handler should interpret any dial events.
Role change (ie pressing mode button 46)
Updates the Role variable that controls which modes can be accessed when operating the Mode button.
Dial events caused by rotation of the dial 48 are handled differently for each DialMode value. These are listed below (limits and step sizes are detailed in the User Interface Specification document):
Volume adjustment—User Role (UR) only.
Increments or decrements the volume variable within limits. The DSP is informed of any change so it can modify the volume control within the signal processing module. The new volume value is stored in EEPROM.
Tone adjustment—UR only.
Increments or decrements the tone variable within limits. The DSP is informed of the change so it can modify the tone filter within the signal processing module. The new tone value is stored in EEPROM.
Transmit level adjustment—Management Role (MR) only.
Increments or decrements the transmit level variable within limits. The new value is translated and sent to the CODEC to alter transmit signal attenuation. The new transmit value is stored in EEPROM.
Receive level adjustment—MR only.
Increments or decrements the receive level variable within limits. The new receive level is translated and sent to the CODEC to alter receive signal gain. The new receive value is stored in EEPROM.
Headset type selection—MR only.
Increments or decrements the headset type variable within limits. The DSP is informed of the new headset type. The DSP retrieves configuration information for the headset and returns pin configuration, earpiece and microphone gains to the MCU. The DSP updates the headset response adjustment filter to suit the selected headset. The new headset value is stored in EEPROM.
Limiter type selection—MR only.
Increments or decrements the limiter type variable within limits. The DSP is informed of the new limiter type and updates signal processing variables to suit. The new limiter type is stored in EEPROM.
   DSP Description

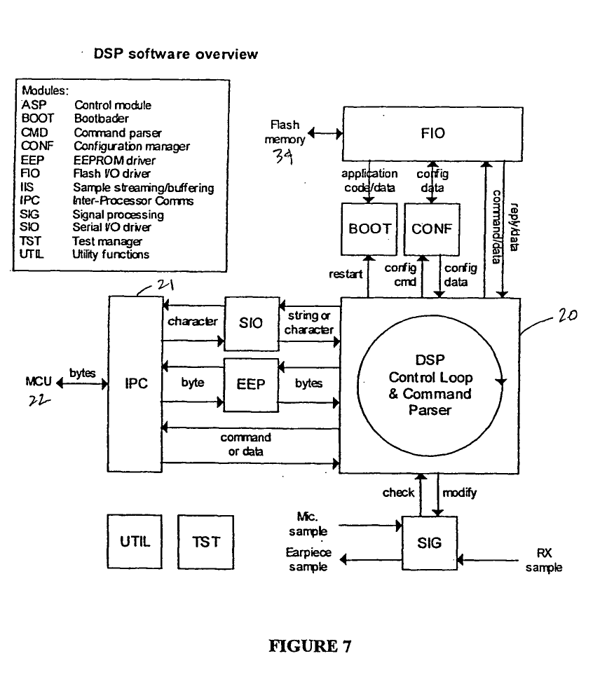

FIG. 7 shows in more detail the interaction between the various DSP software modules.

Initialisation Process

The DSP is not activated until the MCU has booted and configured itself. The MCU then allows the DSP to boot by deactivating the DSP reset signal.

The DSP will boot in the normal way (for instance as described in the Texas Instruments c3x Family User Guide). Interrupts are configured to cause booting from address 0×400000 (BOOT2). The DSPs ROM based bootloader loads the Interface device 4 boot application, details of which can be found in the description of the BOOT module described later.

After the main interface device 4 application has been copied from external Flash memory to the DSPs internal SRAM and data initialisation tables have been processed, initialisation begins. The hardware and software timer are configured, DSP cache enabled, I/O pin functions assigned and interrupts enabled. Next, the IPC channel is initialised. The DSP sets up its local variables, enables the interrupt allocated to IPC and instigates transfer of the message IPC_RUTHERE. The MCU is waiting to process messages and will reply with IPC_YESIAM. The DSP waits 3 seconds for this message and if it is received, continues with the initialisation process. If not received in timer the DSP fails initialisation and resets the interface device 4.

Next, the type of Flash installed (Refer to the Flash I/O description) in the system is identified to allow calculation of the configuration data and the help text addresses. If Flash identification is not successful, the interface device 4 is reset.

Configuration data for the selected headset is loaded. The headset number is retrieved from the MCU and used to locate the configuration data for that headset in Flash memory. Configuration data is detailed in the section covering configuration management. Data the MCU requires is transferred using IPC and data for the DSP is loaded into appropriate variables in SRAM.

Following headset configuration, the signal processing module (SIG) is initialised. This ensures all oscillators, filters and buffers contain the correct values in preparation for receipt of the first sample.

Lastly, the IIS (Inter-IC Sound driver) module is initialised which enables sample interrupts and begins sample buffering. The Administration and Developer passwords are retrieved from the MCUs EEPROM, a command prompt is sent to the serial interface and the IPC_START message is sent to the MCU letting it know the DSP has initialised correctly and is ready to process samples.

Inter Processor Communications

The DSP IPC module is similar to the MCU end. Since the DSP executes around 16 instructions for each executed by the MCU, it waits (all time critical DSP code executes within interrupt service routines so delays in the control loop do not effect signal processing performance) for acknowledgment from the MCU before removing control signals. The following table details IPC commands that may be initiated by the DSP.

| Command | Meaning (DSP initiated) |
|---|---|
| IPC_VOLUME | Requests MCU return the current volume setting. |
| IPC_STATE | Requests MCU return the current state value. |
| IPC_BLOCK_ON | Sets the MCU to serial block mode to provide faster |
| | serial output and unparsed serial input. |
| IPC_BLOCK_OFF | Sets the MCU to standard serial mode. |
| IPC_TONE | Requests MCU return the current tone setting. |
| IPC_CONSTX | Requests MCU return the current console transmit |
| | setting. |
| IPC_CONSRX | Requests MCU return the current console receive |
| | setting. |
| IPC_HEAD_NUM | Requests MCU return the currently selected headset |
| | number. |
| IPC_LIM_NUM | Requests MCU return the currently selected limiter |
| | number. |
| IPC_START | Informs MCU the DSP has completed initialisation |
| | and would like to know the current volume, |
| | tone and state values. |
| IPC_RUTHERE | Enquires whether the MCU is |
| | ready. If all is correct, it |
| | must respond with IPC_YESIAM within 3 seconds. |
| IPC_ERROR | Informs MCU the last message was not understood. |
| IPC_SET_H_CFG | Informs MCU the next 3 bytes to be transferred are |
| | headset configuration data. |
| IPC_SET_{—} | Informs MCU the following byte contains a headset |
| H_NUM | profile number. Occurs when a DSP maintenance |
| | command is used to change the headset profile |
| | number. |
| IPC_SET_{—} | Informs MCU the following byte contains a limiter |
| L_NUM | number. Occurs when DSP maintenance |
| | command is used to change the limiter number. |
| IPC_SET_{—} | Informs MCU the following byte contains a transmit |
| CONSTX | gain value. Occurs when a DSP maintenance |
| | command is used to change the transmit gain. The |
| | value is written directly to the CODEC transmit |
| | output attenuation register. |
| IPC_SET_{—} | Informs MCU the following byte contains a receive |
| CONSRX | gain value. Occurs when a DSP maintenance |
| | command is used to change the receive gain. The |
| | value is written directly to the CODEC receive input |
| | gain register. |
| IPC_SET_TONE | Informs MCU the following byte contains |
| | a new tone value. Occurs when a DSP maintenance |
| | command is used to change the tone setting. |
| IPC_SET_{—} | Informs MCU the following byte contains a new |
| VOLUME | volume value. Occurs when a DSP maintenance |
| | command is used to change the volume setting. |
| IPC_EEP_READ | Requests MCU return the data from its EEPROM. |
| | The following byte contains the address. (Only 256 |
| | EEPROM addresses accessible by DSP). |
| IPC_EEP_WRITE | Requests MCU store data in its EEPROM. The |
| | following byte contains the address. The byte after |
| | that is the data to store. |

Serial Communications

The DSP utilises the IPC module to perform serial communications.

If no command is in progress, data having a value less than 128 (standard ASCII is 0 to 127 or 7 significant bits.) that is transferred to the MCU using IPC, is immediately forwarded to the MCU Serial I/O (SIO) module for re-transmission. Any data received from the MCU having a value less than 128 is held for use by the DSP SIO module. The SIO character reception functions are polled regularly to ensure the IPC receive buffer does not overflow. If the DSP has set the MCU to block mode, data having 8 significant bits can be received. Data to be sent must still have bit 7 cleared.

The SIO module provides standard character and string transmission services. Reception of strings is not standard. The SIO gets( ) function parses received characters as follows:
New line ‘\n’ characters are ignored.
Null characters ‘\0’ are ignored.
Carriage return ‘\r’ terminates a string and causes return of a pointer to the received string unless no characters have been received in which case a NULL pointer is returned.
Backspace ‘\b’ destroys the last received character.
‘;’ indicates the beginning of a comment. Characters between ‘;’ and a carriage return are not stored as part of the string.
The following single character commands are not stored in strings provided they are the first characters received after a carriage return: ‘+’, ‘−’, ‘<’ and ‘?’ (These mean increment, decrement, receive file and help respectively).
Tabs ‘\t’ are replaced with spaces.

All other valid ASCII characters are stored in the string buffer.
A getblock( ) function is provided to collect blocks of 128 bytes of data. The data does not have to be ASCII. It is used during XModem file transfers to receive the XModem data packets.

It will be appreciated by those skilled in the art that the circuitry of the invention can be implemented in various ways. Similarly, the software can be configured in various ways in order to achieve the overall objectives of the controls required by the user during normal use and for maintenance.

It will be also appreciated by those skilled in the art that the device of the invention provides a very convenient and flexible apparatus which can be used to control audio telephony signals.

1. A telephony interface apparatus adapted to interface between a telephony device and a headset, the apparatus including:
control means for controlling functions of said apparatus;
function selection means coupled to said control means for selecting one of said functions;
a rotationally movable dial coupled to said control means for selecting a setting of a selected function by movement of said dial; and
digital display means for displaying said setting.

2. The apparatus of claim 1, wherein the apparatus has a plurality of filter settings stored in a memory thereof, each of said stored filter settings corresponding to respective different frequency response characteristics of different types of said headset and wherein one of said filter settings is selectable by operation of said function selection means in combination with said dial.

3. The apparatus of claim 1, wherein the apparatus is adapted to receive a first audio telephony signal from the telephony device, filter the received signal in order to attenuate shrieks in the received signal and to transmit a second audio telephony signal to the headset.

4. The apparatus of claim 3, wherein the apparatus further includes an analog-to-digital converter for converting the received first audio telephony signal from analog to digital form before filtering thereof and a digital-to-analog converter for converting the filtered signal from digital to analog form before transmission thereof as said second audio telephony signal.

5. The apparatus of claim 3, wherein the apparatus is further adapted to receive a third audio telephony signal from the headset and to transmit a fourth audio telephony signal to the telephony device.

6. The apparatus of claim 5, wherein the apparatus has mute means operable such that when a mute function is applied to the apparatus, said fourth audio telephony signal is not transmitted to said telephony device.

7. The apparatus of claim 1, wherein the apparatus further includes status indicator means for indicating an operational status of the apparatus.

8. The apparatus of claim 7, wherein the status indicator means is formed as a light ring and is disposed around the dial.

9. The apparatus of claim 8, wherein the light ring has a plurality of LEDs for illumination thereof in one of two or more colours.

10. The apparatus of claim 9, wherein the LEDs illuminate the light ring in one colour when a mute function is applied to the apparatus or when the apparatus is turned off and in another colour when the mute function is not applied.

11. The apparatus of claim 1, wherein the control means is a microcontroller adapted to receive input from said dial and said function selection means, to determine said setting of said selected function setting based on said received input, to store said determined setting and to output a display signal to said display means to display said setting.

12. The apparatus of claim 11, wherein the apparatus further includes a digital signal processor in communication with said microcontroller and adapted to detect the presence of a high signal level within an audio frequency range of a first audio telephony signal and to attenuate said high signal level in said first audio telephony signal.

13. The apparatus of claim 1, wherein said function selection means is a mode button disposed on an upper surface of the apparatus.

14. The apparatus of claim 13, wherein when said mode button is pressed once, a setting adjustment mode is initiated and a first function is selected, the settings of said first function being adjustable by movement of said dial.

15. The apparatus of claim 14, wherein when said mode button is pressed more than once while in said setting adjustment mode, further functions may be selected, the settings of said further functions being adjustable by movement of said dial.

16. The apparatus of claim 15, wherein if the apparatus is in said setting adjustment mode and if said mode button is not pressed or said dial is not moved within a predetermined time period, the setting adjustment mode is exited.

17. The apparatus of claim 1, wherein said dial has a substantially flat upper surface with a depression therein for engagement with a finger to rotate said dial.

18. The apparatus of claim 1, wherein said dial is disposed in a raised portion of an upper surface of said apparatus.

19. The apparatus of claim 1, wherein said dial is rotatable clockwise or anti-clockwise without a mechanical limit on the number of revolutions through which it can be rotated.

20. The apparatus of claim 1, wherein said digital display means includes a 7-segment alphanumeric display and a 10-segment bar display and wherein LEDs are used to illuminate said alphanumeric and bar displays.

21. The apparatus of claim 5, wherein the headset includes a microphone and a speaker for transceiving the third and second audio telephony signals, respectively.

22. A telephony interface apparatus adapted to interface between a telephony device and a headset, the apparatus including:
control means for controlling audio telephony filter settings of said apparatus;
selection means coupled to said control means for selecting one of said filter settings from a plurality of stored ones thereof, each of said stored filter settings corresponding to respective different frequency response characteristics of different types of said headset.
